(19) United States
(12) Patent Application Publication
(10) Pub. No.: US 2015/0242895 A1
(43) Pub. Date: Aug. 27, 2015

(54) REAL-TIME COUPLING OF A REQUEST TO A PERSONAL MESSAGE BROADCAST SYSTEM

(71) Applicants: Wendell Brown, Henderson, NV (US); Evan Gregory Tann, Manitou Beach, MI (US)

(72) Inventors: Wendell Brown, Henderson, NV (US); Evan Gregory Tann, Manitou Beach, MI (US)

(21) Appl. No.: 14/629,001

(22) Filed: Feb. 23, 2015

Related U.S. Application Data
(60) Provisional application No. 61/943,280, filed on Feb. 21, 2014.

(51) Int. Cl. G06Q 30/02

(52) U.S. Cl. CPC G06Q 30/0257; G06Q 30/0261; G06Q 30/0267

(57) ABSTRACT

According to embodiments of the present invention, a computer implemented method for responding to an environmental signal associated with inputs from a first computing device is presented. The method includes sensing a first information associated with the environmental signal from a sensor associated with a first computing device and transmitting the first information from the first computing device to a second computing device. The method further includes correlating, with the second computing device, the first information with a second information associated with a user interest to form a correlated data and determining, with the second computing device, a resulting information. The resulting information includes one or more interaction options. The method further includes transmitting the resulting information from the second computing device to the first computing device and displaying the resulting information with the first portable-computing device to a user. The method further includes sending one of the one or more interaction options selected by the user from the first computing device to a selected multitude of computing devices not being the first computing device, such as computing devices belonging to those other than the user.

### CROSS-REFERENCE TO RELATED APPLICATIONS

This application claims benefit under 35 USC 119 (e) of U.S. Provisional Application No. 61/943,280, entitled “COUPLING ADVERTISEMENTS AND COMMERCIAL OFFERS TO A PERSONAL MESSAGE BROADCAST SYSTEM,” and filed Feb. 21, 2014, the content of which is incorporated herein by reference in its entirety.

### TECHNICAL FIELD

The present invention relates generally to a method and system for real-time responding to a user request from a computing device, and in particular to displaying one or more interaction options associated with feedbacks to the computing device and sending one or more interaction options associated with feedbacks to other computing devices.

### BACKGROUND

Desktop and portable-computing devices such as laptops have been supplemented by wearable-computing devices and mobile devices such as mobile phones and tablets. Portable computing devices contain a variety of sensors and data input devices. Typical information, hereinafter also referred to as “data”, from portable-computing devices includes; global positioning system (GPS) location, wireless network status, mobile cell phone tower location, device acceleration, audio inputs, video inputs, fingerprint sensors, ambient light inputs, information about other devices associated or nearby the user's portable-computing device, e.g. tethered Bluetooth® devices, and/or like data.

Some portable computing devices can be called wearable computing devices when in their primary usage they are attached to a human body. Examples of wearable computing devices are smart-glasses, smart-watches, smart-microphones, smart-necklaces, smart clothing, augmented reality wearable devices, permanently installed (implanted) or semi-permanently installed wearable computing devices and the like. Therefore, any sensor attached to body with a minimum computing capability such as transferring information can be seen as a wearable computing device.

A user of computing devices may be associated with various online social or other account information, such as Facebook, Twitter, LinkedIn and other similar accounts or networks. Some online social account information may be fed or streamed to a user's portable-computing device as an information feed based on #hashtags, e.g. keywords, that relate to the user's interests.

An advertisement, hereinafter also referred to as an “ad,” is used to market and sell a product or service by seeking and offering potential-market users or responding and offering a user upon his request. Typical ads contain primary information in the form of text, images and/or audio information about a product or service. The primary information in the ad may also contain information, such as a toll-free 800 number, a website address, a physical street address, or another means of action, that provides a way for the viewer or listener to take an action to either buy the product or Obtain more supplemental information related to the ad. Magazine and video ads, roadside billboards, street-level ads, posters in the subway or bus stop, digital-out-of-home advertisements, kiosks, ads on vehicles such as taxis, buses, cars, ads for virtual goods (e.g., a music download, a mobile phone app, etc) and the like, contain similar information.

An offer is used to market and sell a product or service. An offer from a merchant may be sent to a user, a user's friends, as a response to a user (or a user's friend's') inquiry, intent, stated desire, or message. Typical offers contain primary information in the form of text, images and/or audio information about a product or service. The primary information the ad may also contain information, such as a toll-free 800 number, a website address, an offer or another means of action that provides a way for the viewer or listener to take an action, for example instructions to buy the product (e.g. Call 1-800, visit www.usedcars.com) the product or obtain more supplemental information related to the ad. Magazine and video ads, roadside billboards, street-level ads, ads on vehicles such as taxis, buses, cars, and the like, contain similar information.

### BRIEF DESCRIPTION OF THE DRAWINGS

FIG. 1 depicts an exemplary simplified classification and a flow of information in which one or more blocks of information may be associated with a real-time user request, in accordance with one embodiment of the present invention.

FIGS. 2A-2D depict an exemplary simplified networked system that may incorporate embodiments of the method depicted in FIG. 1 using a first wearable-computing device, in accordance with one embodiment of the present invention.

FIG. 2A depicts a simplified block diagram of a first wearable-computing device, in accordance with one embodiment of the present invention.

FIG. 2B depicts a simplified block diagram of a portable computing device wirelessly tethered to the wearable-computing device depicted in FIG. 2A, in accordance with one embodiment of the present invention.

FIG. 2C depicts a simplified block diagram of a world-wide-web or cloud network linked to the wearable-computing device depicted in FIG. 2A, in accordance with one embodiment of the present invention.

FIG. 2D depicts a simplified block diagram of the wearable-computing device depicted in FIG. 2A sensing an advertisement, in accordance with one embodiment of the present invention.

FIG. 3 depicts an example of a simplified computer network for responding to an environmental signal associated with inputs from a wearable-computing device, in accordance with one embodiment of the present invention.

FIG. 4 depicts an exemplary operation that may be performed by a portable computing device, in accordance with one embodiment of the present invention.

FIG. 5 depicts an exemplary operation that may be performed by a server, in accordance with one embodiment of the present invention.

FIGS. 6A-6F depict an exemplary simplified system that may incorporate embodiments of the method depicted in FIG. 4, in accordance with one embodiment of the present invention.

FIG. 6A depicts a simplified perspective view of a wearable-computing device with an exemplary visual display output, in accordance with one embodiment of the present invention.

FIG. 6B depicts a simplified block diagram of a world-wide-web or cloud network linked to the wearable-computing device depicted in FIG. 6A, in accordance with one embodiment of the present invention.

FIG. 6C depicts a simplified perspective view of the wearable-computing device depicted in FIG. 6A with an exemplary visual display output, in accordance with one embodiment of the present invention.

FIG. 6D depicts a simplified perspective view of a wearable-computing device depicted in FIG. 6A with an exemplary visual display output, in accordance with one embodiment of the present invention.

FIG. 6E depicts a simplified front view of a recipient's portable computing device similar to the portable computing device depicted in FIG. 6B with an exemplary visual display output, in accordance with one embodiment of the present invention.

FIG. 6F depicts a simplified perspective view of the second wearable-computing device depicted in FIG. 6A with a fourth exemplary visual display output, in accordance with one embodiment of the present invention.

FIG. 7 depicts a simplified block diagram of a computer system that may incorporate embodiments of the present invention.

### SUMMARY

In one embodiment, a method for broadcasting a request by a first device is disclosed. The method includes, in part, determining first information corresponding to a location of the first device. The method further includes, in part, transmitting the first information and a user request to a server, said user request to be transmitted to one or more devices in a first set of devices associated with the first device. The method further includes, in part, receiving at least one resulting information in response to the user request, and displaying the at least one resulting information to the user of the first device.

In one embodiment, the method further includes, in part, transmitting one or more lists of devices associated with a user of the first device to the server. In one embodiment, the method further includes, in part, receiving one or more advertisement elements from the server, and displaying the one or more advertisement elements to the user. In one embodiment, the one or more advertisement elements are displayed in a ranked order. In one embodiment, the method further includes, in part, receiving an input corresponding to a selection of at least one of the advertisement elements from the user. in one embodiment, the method further includes, in part, transmitting the input to the server.

In one embodiment, displaying the at least one resulting information further includes, in part, transmitting the at least one resulting information to a second device associated with the user of the first device to be displayed to the user. In one embodiment, the first information corresponds to measurements from one or more environmental sensors. In one embodiment, the first information correspond location information associated with an interact protocol (IP) address of the first device.

A method for broadcasting a request by a server is disclosed, the method includes, in part, receiving a user request and first information corresponding to a location of a first device. The method further includes, in part, correlating first information with a second set of information to select one or more devices from a first set of devices. The method further includes, in part, transmitting the user request to the selected one or more devices. The method further includes, in part, receiving at least one resulting information from at least one of the selected one or more devices in response to the user request. The method further includes, in part, transmitting the at least one resulting information to the first device.

In one embodiment, the method further includes, in part, selecting one or more advertisement elements from a third set of data according to the user request, and transmitting the one or more advertisement elements to the first device. In one embodiment, the method further includes, in part, ranking the one or more advertisement elements according to the user request.

### DETAILED DESCRIPTION

According to embodiments of the present invention, a computer-implemented method for responding to a user request given to a first computing device is displayed. The method includes a first processing associated with the user request by the first computing device and transmitting a first information from the first computing device to a second computing device. The method further includes correlating, with the second computing device, the first information with a second information associated with a user interest to form a correlated data and determining, with the second computing device, a resulting information. The resulting information includes one or more interaction options. The method further includes transmitting the resulting information from the second computing device to the first computing device and displaying the resulting information with the first portable-computing device to a user. The method further includes sending one of the one or more interaction options selected by the user from the first computing device to a selected multitude of computing devices not being the first computing device, such as computing devices belonging to those other than the user.

In one embodiment, information from a multitude of sources may thereby be correlated, filtered, selected and ranked according to a user's interests and current environment, in real-time. The information from the multitude of sources may include real-time data inputs and/or non-real-time data inputs. The ranked information, such as coupons, offers, ads and/or the like, may be output on a computing device in real-time. The user is thus presented with more useful or relevant real-time output data than currently possible with existing Internet search techniques that, in-contrast, input and output static web pages that may not be current, active, or take into consideration the user's environment in real-time. In one embodiment, the user's interests are declared interests, such as through active or passive feedback from the user. In another embodiment, the user's interests may be predicted or anticipated automatically. In one embodiment, the information from the multitude of sources may be streamed information. In another embodiment, the information from the multitude of sources may not be streamed information. In one embodiment, the output data may be streamed information. In another embodiment, the output data may not be streamed information.

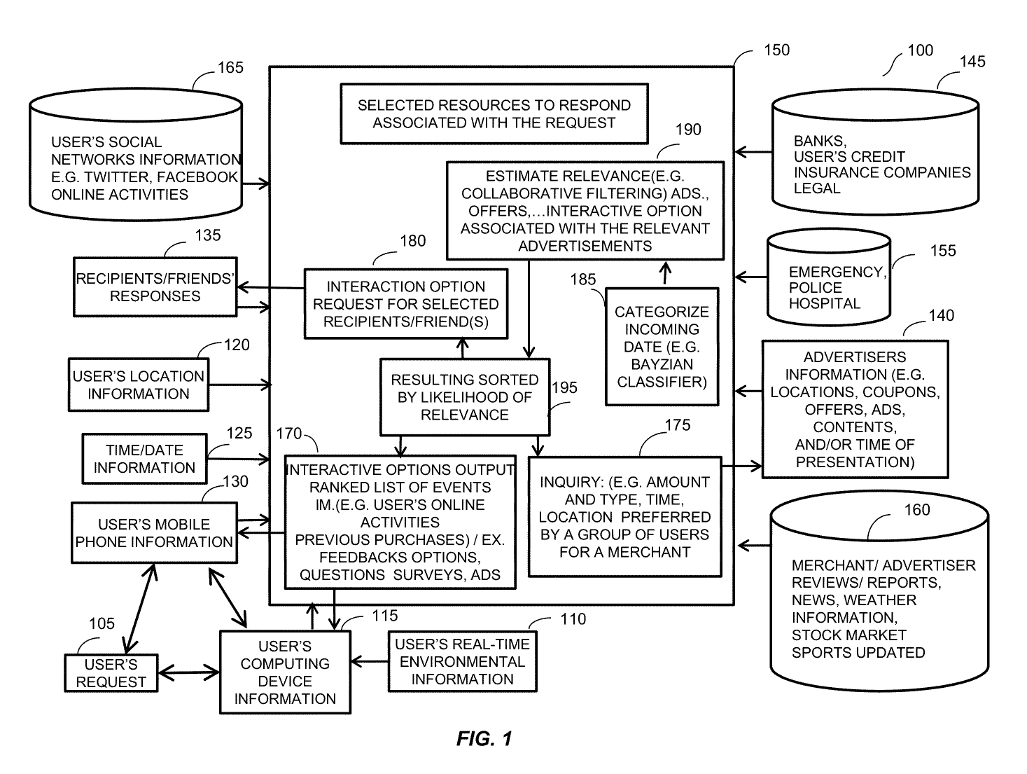

FIG. 1 shows a flow chart of information 100 in a simplified computer-implemented method for responding to an environmental signal associated with inputs from a user's computing device, in accordance with one embodiment of the present invention. 100 shows how different resources of information may enter to a computation process. Blocks shown in 100 are associated with a general clustering of available resources of information which may comprise location, level of processing or level of importance. Processed information block 150 is the data relevance engine. Information may be fed back to some information sources from after processing.

A desktop computing device is a computing device with a processor that would not typically be carried or moved about in normal use. A portable-computing device may include a laptop, mini-laptop, tablet, pad, mini-tablet, mini-pad, cell-phone, smart-phone, which include a processor and a sensor. A portable-computing device may further include one or more wearable-computing devices. A wearable-computing device may include any of; an eyeglass, an ear-piece, a wristband, a wrist-device, a medallion, a device worn around the neck, an arm band, an arm-device, a device worn on the head such as a hat, a piece of clothing such as a shirt, a pair of pants, a scarf, and the like, a piece of outer clothing such as a coat, jacket, or the like, and other wearable-computing devices, which include a processor and a sensor. Accordingly, a wearable-computing device is different from a laptop, which is not worn on a user's body.

Further, the portable-computing device in real-time senses primary information about the environment in the local vicinity, line-of-sight, and/or hearing distance adjacent the portable-computing device via the sensor(s) associated with the portable-computing device. At least one sensor on the portable-computing device senses 110 primary information, hereinafter also referred to as an “environmental signal”, such as location information (such as GPS or cellular location information), altimeter elevation, device acceleration, motion, audio, video, fingerprint, heart rate, breathing rate, retina scan, and/or other biometric sensors, ambient light, near-field communication, wireless network status, infrared, ultrasonic, gyroscopic, orientation, and/or the like. The portable-computing device may include a multitude of such sensors to sense information associated with the user's environment in real-time.

A desktop or other computing device may automatically sense information via tools built into a web browser, operating system, or other program or process that allows an application to request the desktop computing device's location without requesting such information via a user's direct actions or following a user's grant of permission (e.g. “May we determine your location automatically?”). Further, an IP address or a known Wi-Fi network connection may be used to “sense” the location of a user.

Further, a sensor may be associated with a first computing device through another computing device that is different than but tethered wirelessly or by wire to the first computing device or desktop computing device in various combinations. In other words, a sensor need not be on the user's first computing device but may be associated with the user's first computing device. For example, an audio microphone may be located on an earpiece wirelessly connected to a first computing device, such as a smart-phone having a microphone worn in the ear (an earpiece). Another example of connected sensor is a bicycle's digital speedometer, which may be transmitting information to the first computing device.

A multitude of information inputs each from a different one of a multitude of sensors in the computing device may be transmitted in real-time as an information stream. Any number of sensors may be tethered in a local network to provide data of interest associated with the user's environment or where the user is located, such as sitting at a desk, on a bicycle, automobile, plane, or other transportation vehicle. Accordingly, sensors are neither associated with keyboard keys or keyboard icons, nor are the real-time sensor data the same as data that is user-inputted via keyboard keys. In one embodiment, data from a user's portable-computing device's body motion sensors are used to correlate and weight data inputs. In one embodiment, data from a user's wearable-computing device that indicates the user's location, such as GPS information, cell phone tower, and/or the like, is used to gather, correlate, weight and then rank the output data.

Primary information may be directly sensed from the local environment in real-time, such as an ad that is sensed by visual, audio, or electronic means by the portable-computing device or the user, as will be described in more detail below. Further, primary information may also be data requested by the user through the first-computing device such as a feed, tweet, web page, e-mail, or the like. In contrast, secondary information, hereinafter also referred to as “supplemental information” is information that is not primary information, as described below.

The primary sensor information is transmitted 115 from the user's first computing device to a second computing device called a data relevance engine via cable, radio, infrared, or other Internet network link. In one embodiment, data from one or more real-time sensors is passively collected, e.g. an audio or video sensor data may be continuously transmitted in real-time, for a predetermined period of time. The predetermined period of time may be chosen by the user via controls in the first computing device. In one embodiment, primary sensor information is transmitted upon request or demand, or upon a timed predetermined sequence. In one embodiment, primary sensor information is transmitted 115 continuously in time as an information stream, the sensor information following the changes in the environment as the user moves through that environment, not only as geographic location changes but further including changes in the users orientation, such as what the user's wearable-computing device may be seeing or hearing in real-time.

In one embodiment, the data relevance engine is a second computing device located in the Internet cloud, which may provide a critical advantage of not adding additional computational or data storage burdens on the first computing device that increases battery life and performance when the first computing device is a portable-computing device. In another embodiment, the data relevance engine may be located in the user's first computing device. In one embodiment, one portion of the data relevance engine is located in the Internet cloud, while another portion of the data relevance engine is located in the user's first computing device. In one embodiment, the data relevance engine performs calculations in one or more computing devices, e.g. servers “in the cloud”, with such computing devices connected to a user's portable, mobile, or wearable-computing-device via a wireless connection, such as a WiFi, mobile data network, Bluetooth, or similar network, or via a wired connection, such as Ethernet.

The user may have a request expressed in many different forms. In one embodiment a request can be a simple message such as “I want just coffee” or a more detailed message such as “I want coffee in the next two hours for less than $5 with my friends Bill and Ted” thus including a number of criteria which might be associated with price range, time, location, due time, people or social groups, or other information. In one embodiment the request can be a complex request that can include multiple requests in a time frame. In one embodiment a request might be urgent in its nature such as a medical need or an un-urgent such as a shopping and thus be prioritized in the processing or delivery of the message above other requests.

In one embodiment the first computing device analysis the request to get the request content and other factors inherent with techniques in fields such as Natural Language Processing or Image Recognition, such as determining the relationship and meaning of words in the request by computer or computer-assisted action. In one embodiment request criteria may be associated with priorities. For example, in a request with two criteria of due-time and location, due-time might have a higher priority than the location.

The information processing network 100 may send the information and get feedback from the user, his social links, advertisers, and other related information sources. The data relevance engine may classify, correlate and rank these inputs. An efficient method in processing with the minimum time and information resource can help with the performance of the system.

In one embodiment, the primary information is transmitted from the portable-computing device to the data relevance engine directly. In another embodiment, the primary information is transmitted from the portable-computing device to the data relevance engine indirectly, e.g. from a wearable-computing device tethered to the portable-computing device, such as a smart phone.

In one embodiment, the primary information may include automatic browser based location information, IP address geographic data, WiFi connection location, global positioning system (GPS) and/or cellular network positioning location for a user's first computing device. The GPS and/or cellular location information may be transmitted 120 from the first computing device to the data relevance engine periodically or in real-time. The first computing device may be a portable-computing device in motion and its position transmitted providing current location, speed and/or direction-information that may be used by the system to predict likely future location.

In one embodiment, the primary information may include time and/or date information for the user's first computing device. The time and/or date information may be transmitted 125 from the first computing device to the data relevance engine. In another embodiment, the time and/or date information is available to the data relevance engine, which then correlates or time and/or date stamps the received primary information accordingly.

In one embodiment, the primary information may include information associated with the first computing device, such as contacts, prior, e.g. historical location data of the device, email addresses, account, serial, identification, model, firmware, web address, stored photo or video, historical browser information such as prior purchases and/or payments, and/or the like. The information associated with the first computing device may be transmitted 130 from the first computing device to the data relevance engine.

In one embodiment, secondary information may be associated with a user interest from the user's social network in the cloud, such as likes, dislikes, social graphs, social graph elements, friends, thumbs up, thumbs down, email addresses, stored photo or video, product or service reviews, #hashtags, tweets and/or the like. The information associated with the user's social network, such as Facebook, may be received 165 from the cloud by the data relevance engine. In one embodiment, the user is associated with the first computing device.

In another embodiment, the user may not be associated with the first computing device. For example, the user may be a social network friend of or someone who recommends the user who is associated with the first computing device. Then the data may include recommendations, preferences, or interests of a user who is not associated with the first computing device but is still associated through the social network with the user who is associated with the first computing device. Thereby, the data relevance engine may have access to a multitude of user interest data from users who may share similar interests as the user associated with the first computing device. In one embodiment, other sensors in the user's nearby location, such as sensors associated with other nearby users, fixed sensors, and/or the like may be used as primary real-time inputs. In one embodiment, data in a user's social graph, for example such as the Facebook social graph, or other similar user data, such as the user's friends or friend's likes, are used to correlate and weight data inputs.

In one embodiment, secondary information may be associated with advertiser information or ads. The information associated with the ads may be received 140 from the cloud or from other sources by data relevance engine, in one embodiment, the information associated with the ads may include a geographic location, orientation, viewing angles, direction or heading for viewing the ad, coupons, offers, ads, contents, time of presentation, and/or the like for at least one ad. In one embodiment, an advertisement may be static in the form of fixed media such as paper, printed, and/or painted or electronic media such as LED signs. In another embodiment, an advertisement may be dynamic or active display, such as electronic media including LED signs or signs with physically changing structure, such as a rolling sign, capable of displaying different ads at different times at the same geographic location. For example, a billboard in a stationary location may be an active display that changes between a multitude of ads from time to time or periodically, with known predetermined display times for a particular ad. In another example, the bill board's display surface may be oriented substantially perpendicular to a direction of an adjacent road so as to be seen primarily from the direction of approaching traffic along the road, that traffic including a user wearing or carrying the portable computing device with sensor.

In one embodiment, the ad may be located on a moving object such as in a bus, subway car, taxi, blimp and the like and the real-time velocity, speed, expected position, and/or expected position in time of the ad may be calculated or determined via GPS and/or cellular phone tower, or other location means and transmitted to the system. In another embodiment, the ad may be in any combination of static, dynamic, stationary or moving type ad with associated information received by the system. For example, a dynamic LED sign that periodically changes between different ads on a roof of a moving taxi. In one embodiment, the information associated with the ads may be stored in a database or similar data storage accessible to the system. Such ad information may be correlated by the system with information sensed by the user's first computing device to determine ad ranking to display ad information and/or interaction options associated with the ad to the user's first computing device that are of immediate relevance to the user as will be described below.

In one embodiment, primary and/or secondary information may be associated with external information sources, which are linked and/or accessed 160 by the data relevance engine. External information sources may include any kind of information source or service that may push, feed, transmit, or be accessible as information to the first computing device not included in the information input embodiments already described above. Examples of external information sources include Yelp, Groupon, broadcasting networks, such as NBC Sports or National Public Radio, financial information services, email services, text messaging services, geographical map database services, weather reporting and/or prediction, historical information such as purchase, payment, or credit history, other websites and/or the like.

In one embodiment, the first computing device may cache, pre-cache, look-ahead cache, predictive cache, local area cache, or other form of look ahead caching/fetching to efficiently, and/or quickly retrieve one or more elements of information. In one embodiment, a real-time database may be used to store and house the information. Information about the user, that may eventually be sent to the merchant/advertiser, may be fetched from a pre-stored location either on the first computing device or from another location, e.g. stored in the second computing device, in the cloud, and/or stored in a user's account/preferences settings.

In one embodiment, primary and/or secondary data may be correlated 150 in real-time by the data relevance engine to determine the resulting information in a ranked order associated with the correlated data. In other words, the data relevance engine correlates the primary information or environmental signals, e.g. from the real-time sensors on the user's first computing device, with secondary information, e.g. data from social media networks, associated with a user interest, to form a correlated data. The data relevance engine then determines a resulting information as an output. The resulting information includes real-time information in a ranked order or unranked information that has been filtered to keep information that is of interest to the user. The ranked order is associated with the correlated data.

In one embodiment, the data relevance engine correlates the primary information or environmental signals, e.g. from the real-time sensors on the first computing device, with information associated with at least one advertisement in addition to or in any combination with the information sources described above, to form the correlated data and determine at least one relevant advertisement. The resulting information may include real-time information of ads in a ranked order of relevance to the user. The ranked ad order is associated with the correlated data. For example, an ad may be deemed by the system to be a relevant ad when the ad is in good current viewing distance and orientation relative the user's first computing device because it may be given a higher weighted ranking than an ad that is located farther away. In one embodiment, resulting information determined by the data relevance engine may include one or more interaction options associated with the at least one relevant ad. In one embodiment, the system may inform or display that an ad of real-time interest is available to the user, via the first computing device. In one embodiment, the real-time interest may be in accordance with the user's prior historical information, social graph, Likes, other inputs from the user or user's friends, and/or the like.

Because the primary and/or secondary data that is included in the correlated data is associated with user interest data, the ranked order will therefore be associated with the user's interests. Further, because the primary data includes current sensor data associated with the local environment adjacent the user's first computing device, and thereby with the user, the ranked order will be associated with activities or locations the first computing device is encountering in real-time, without requiring much, if any, input by the user. The use of the real-time sensor data associated with the immediate environment of the user's first computing device provides a critical advantage that improves the relevance of the ranking over the relevance that can be obtained by previously known techniques. In one embodiment, the resulting information may be streamed continuously or periodically. In another embodiment, the resulting information may not be streamed.

In one embodiment, the data relevance engine makes its determination of the rank order automatically, without active user input, using passively collected data from primary and/or secondary data inputs that are associated with the user's interests. In another embodiment, the data relevance engine makes its determination of the rank order semi-automatically, with some active user input during a learning period for the data relevance engine or during occasional subsequent times when the user wants the output of the data relevance engine to be adjusted or changed, for example when the user's interest changes.

The resulting information and ranked order may be transmitted 170 from the data relevance engine to the first computing device associated with the user, where the ranked resulting information may be available to the user's senses. The ranked resulting information may be visually, audibly, or tactilely available to the user via the third computing device. In one embodiment, the first computing device may be different than the first computing device. In one embodiment, the first computing device may be tethered via wireless or wired direct communication link to a third computing device, both first and third devices in close proximity to or on the user.

In one embodiment, the resulting information may be displayed such that the predicted most relevant data is displayed first or in a form of higher visibility than less interesting data. In other embodiments, the resulting information output may be included as a standalone app or may alternatively be included in a portion of another app, e.g. a monetization/embedded stream within another app. In one embodiment, when the first computing device is a portable-computing device, the portable-computing device's detected motion sensor information may be used to change/update/scroll/move the contents of the displayed resulting information.

In one embodiment, a multitude of advertisements that are relevant/related in real-time to the primary and/or secondary data inputs and thus selected to match the user's real-time interests may be inserted into the resulting information. In one embodiment, at least one advertisement, which is deemed to relate in real-time to at least one of the data input sources, may be displayed in the resulting information output data stream. In one embodiment, at least one merchant offer, or coupon, for example such as a local daily deal, which may be deemed to relate to at least one of the data input sources, may be included in the output data stream.

In one embodiment, the resulting information may include an actionable link and/or one or more interaction options associated with at least one relevant ad. For example, the actionable link may direct the user's browser to a website that may initiate a purchase of a service or product. In one embodiment, the user may select one of the items in the multitude of items included in the resulting information.

In one embodiment, a portion of the resulting information may be continuously updated in real-time. In another embodiment, a portion of the resulting information may be updated at a predetermined time when the data relevance engine determines the resulting information should be updated due to a change in one of the multitude of information inputs. In one embodiment, the resulting information may be updated periodically. In one embodiment, the ranking of the resulting information may be updated dynamically at predetermined times when the data relevance engine determines a new ranking order is appropriate due to changes in one of the multitude of information inputs.

In one embodiment, the resulting information output may be displayed to the user such that the ranking value of most relevant or interesting resulting information is more easily consumed or understood by the user than the lower ranked, less interesting resulting information. In one embodiment, the resulting information may be displayed visually as a list of information ranked in order from most interesting information displayed first, such as at the top of a list, and the less interesting resulting information displayed in sequence of a rank value, such as from top to bottom of the list with the least interesting information displayed at the bottom of the list.

In another embodiment, the resulting information may be displayed as audio output, such as an audio announcement displaying the most interesting resulting information first in sequence of a rank value. Less interesting information may be displayed after the most important resulting information displayed in sequence of a rank value, such as from first to last in the sequence with the least interesting information displayed at the end of the sequence.

In one embodiment, the resulting information may be displayed in a repeating sequence. In one embodiment, the repeating sequence of the resulting information may repeat the resulting information that has higher rank order at greater frequency than the less interesting resulting information with lower rank order. In one embodiment, the resulting information may be displayed at a time associated with the ranking value.

In one embodiment, the resulting information may be displayed in a format associated with the ranking value. In one embodiment, the format of the resulting information that has higher rank order may be displayed to draw greater attention than the less interesting resulting information with lower rank order. For example, resulting information that has higher rank order may be displayed in holder, larger, flashing frequency, and/or colored font associated with the ranking value for a visual display, or by type of voice and/or volume for an audio display.

In one embodiment, after the ranked real-time interaction options in the resulting information are perceived by the user on the user's first computing device, the user may select one of the interaction options. Then the system may send at least one of the one or more action options from the first computing device via a second computing device, e.g. a server, to a selected one or more computing devices not being the first computing device. The sending of the at least one of the one or more interaction options may include sending 105 a request from the first computing device to the second computing device. The request may include the at least one of the one or more interaction options, for example the user may want to have coffee at a local vendor. Then the data relevance engine may determine, using the second computing device, the selected one or more computing devices other than the first computing device.

The interaction option request may then be sent 180 or broadcast to the selected one or more computing devices or recipients by the second computing device. The data relevance engine in the second computing device may select which recipients receive the interaction option based upon, for example, real-time geographic location of the recipients, preselected default recipient categories, and/or recipient categories selected on the first computing device contemporaneously when the user selects the interaction option.

A response from at least one of the selected one or more computing devices, i.e. computing devices of recipients and/or friends, may then be transmitted 135 to the second computing device. The response may include an acceptance or denial of the user's request. The response from the second computing device may then be transmitted to the first computing device informing the user of the results of the request.

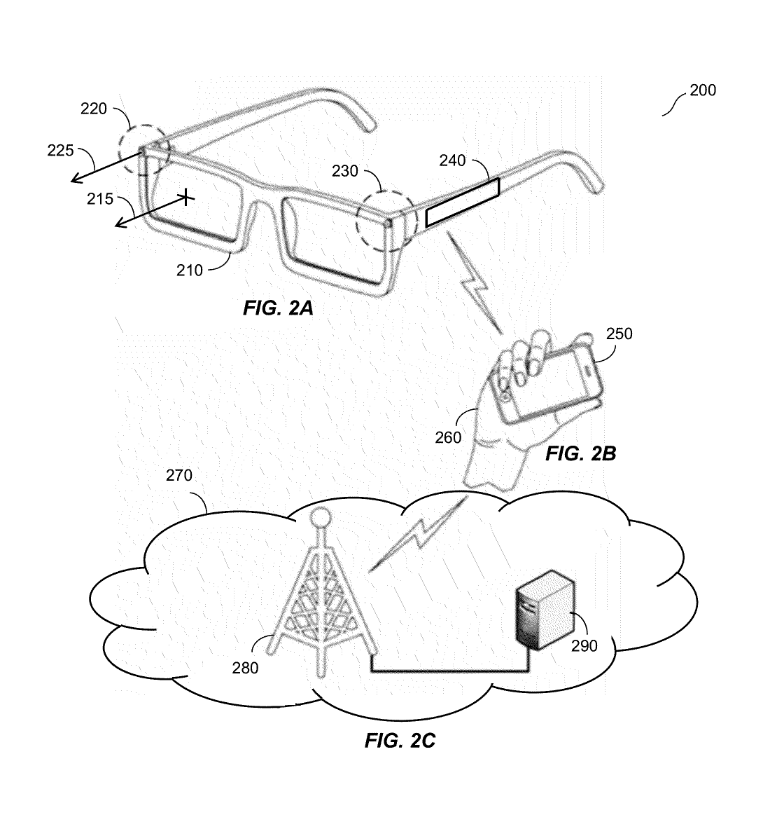

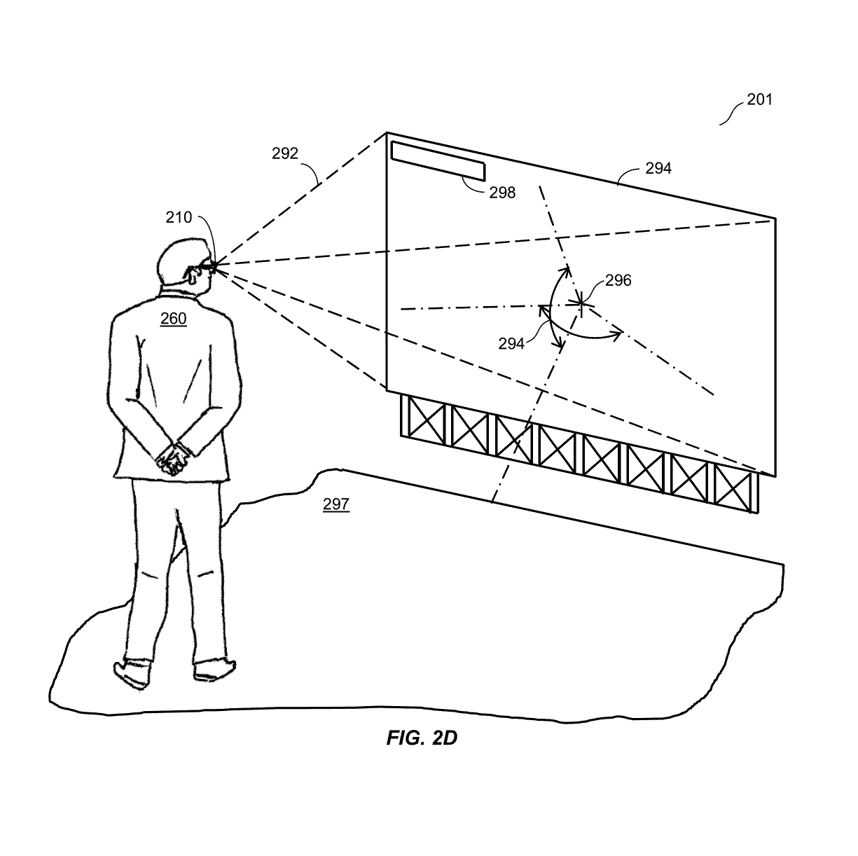

FIGS. 2A, 2B, and 2C redisplay a simplified block diagram of a networked information system for a first wearable-computing device 200, in accordance with one embodiment of the present invention. FIG. 2A is a simplified block diagram of first wearable-computing device 210, in accordance with one embodiment of the present invention. In this example, first wearable-computing device 210 includes a form factor for eyewear with one or more displays and may include a sensor such as one or more camera 220, and/or a microphone 230. Camera 220 may include a video and/or a still camera or multiple cameras and one or more optical axis 225 oriented such that the video camera's field of view is aligned with the line of sight of the user 215. In other words, camera 220 may see the same image the user sees through the eyewear of first wearable-computing device 210. In one embodiment, the sensor may be on continuously or periodically over a predetermined period of time seeing or hearing whatever the user sees and hears in the vicinity of the user.

First wearable-computing device 210 may further include an electronic circuit 240. Electronic circuit 240 may in-turn include one or more inputs such as a touch sensor or button, a processor, a data store, and a battery. In one embodiment, electronic circuit 240 may include a wireless radio transceiver. In one embodiment, the wireless radio transceiver may operate on low bandwidth, power saving radio transmission standards such as Bluetooth®, 6LoWPAN®, ZigBee®, Z-Wave®, MiWi®, or OSION®. In another embodiment, the wireless radio transceiver may operate WiFi®, or cellular radio transmission standards. The first wearable-computing device 210 may be able to project images received by electronic circuit 240 to the user wearing first wearable-computing device 210 through the lenses of the eyewear such that the projected image is seen by the user superimposed over the real image as viewed by the user. Therefore, the resulting information transmitted from the data relevance engine may be visually displayed in the user's field of view on first wearable-computing device 210.

In one embodiment, electronic circuit 240 may further include an audio output device, such as a speaker or bone transducer. Therefore, the resulting information transmitted from the data relevance engine may be audibly played to the user via the audio output device on first wearable-computing device 210. In one embodiment, electronic circuit 240 may further include GPS, cellular location, and/or orientation circuitry, which may respectively determine the location and/or height on the earth and the orientation at that location of first wearable-computing device 210. In other words, orientation circuitry may provide to first wearable-computing device 210 the direction video camera 220 and the user are viewing, for example, compass or azimuth and altitude angles relative to the user. In one embodiment, electronic circuit 240 may further include a gravitational sensor and/or an accelerometer, which may provide a velocity information and/or an acceleration information for first wearable-computing device 210

FIG. 2B is a simplified block diagram of a portable-computing device 250 wirelessly tethered to the first wearable-computing device represented in FIG. 2A, in accordance with one embodiment of the present invention. FIG. 2B shows an example where portable-computing device 250 is a smart phone, however, portable-computing device 250 may be any portable computing device such as a laptop, mini, tablet, or pad, which may or may not include a wireless radio transceiver that may link or tether portable-computing device 250 to first wearable-computing device 210 on user 260. In one embodiment, portable-computing device 250 may be tethered to first wearable-computing device 210 via a wire and a wired communication system connecting first wearable-computing device 210 to portable-computing device 250. In one embodiment, location, orientation, gravimetric and/or acceleration sensors may be included in portable-computing device 250 or distributed between first wearable-computing device 210 and portable-computing device 250 in any combination. Portable-computing device 250 may further include a cellular radio transceiver or WiFi® radio transceiver that may link portable-computing device 250 to the world-wide-web or cloud network shown in FIG. 2C.

Portable-computing device 250 may further include a display. In one embodiment, the system may transmit a first portion of the resulting information, e.g. ranked or unranked resulting information output, indicator, logo, ad, and/or the like, to first wearable computing device 210 and the remaining portion in any combination to portable-computing device 250. In one embodiment, the system may display a first portion of the resulting information, e.g. ranked output data, to first wearable computing device 210 and the remaining portion in any combination to portable-computing device 250.

FIG. 2C is a simplified block diagram of a world-wide-web or cloud network 270 linked to first wearable-computing device 210 represented in FIG. 2A, in accordance with one embodiment of the present invention. FIG. 2C shows a base station 280 for sending or receiving cellular or WiFi® radio transmission to or from portable-computing device 250, respectively. Base station 280 may be coupled to one or more server 290 computing devices. In one embodiment, a multitude of servers may be located in different locations or in multiple clouds. In another embodiment, first wearable-computing device 210 may include a cellular radio transceiver or WiFi® radio transceiver directly providing the link to the world-wide-web or cloud network shown in FIG. 2C without portable-computing device 250 serving as the intermediary communications link.

FIG. 2D shows a simplified block diagram 201 of first wearable-computing device 210 depicted in FIG. 2A sensing 292, represented by dashed lines, an advertisement 294, in accordance with one embodiment of the present invention. The ad information stored in the system's database may include viewing angles, direction or heading where the ad may be viewed 296, represented by dashed and dotted lines and geographic location 296 of the ad in relation to a path or road 297 user 210 may be located on. When the location information of user 210 and the orientation information from first wearable-computing device 210 are in the primary information, the location and orientation information and, optionally, the camera or microphone sensor's real partial input, may be correlated with the ad information to predict a probable ad the user is likely viewing, and/or hearing. Data associated with the ad may then be transmitted in the resulting information to the at least one of first wearable-computing device 210 and/or personal computing device 250 tethered to first wearable-computing device 210.

In one embodiment, the at least one of first wearable-computing device 210 or personal computing device 250 tethered to first wearable-computing device 210 then may re-create the ad for the user or create a simulated view, e.g. a virtual view, or sound to be seen/heard by the user of the probable advertisement the user should be seeing or hearing. In one embodiment, primary or supplemental information may be modified by time of day, day of the week, user's preferences, user's detected preferences, user's prior activities, or other similar information or variables. In one embodiment, a video or camera sensor is sensed for any possible text input or ad identification code 298 located in the ad, the text or code of which is then fed into the data relevance engine input. In one embodiment, a viewer's wearable computing device could further detect the advertisement by means of optical sensors, via a camera, infra-red, Bluetooth, Wifi or near-field or other wireless communication means, and or the like.

In one embodiment, when the location data of first wearable-computing device 210 that is in motion may be correlated with environmental signal data from its sensors to determine a probable future location of first wearable-computing device 210 in order to proactively determine resulting information before the first wearable-computing device 210 reaches an ad's or event's location. In one embodiment, a hash table approach or similar proximity detection algorithm or other sorting/distance-related method is used to match a real-time sensor information from the portable computing device to potential “matched” ads or activity venues. When a sensor's field of view, or potential field of view, matches or is within or near the viewing angle of the ad or activity venue then a “match” is found and the portable computing device and user associated with the sensor may be alerted or otherwise notified. In one embodiment, a user's “matches” may be stored in the portable computing device and/or in the cloud (in the user's account) to enable to user “history” of matches be displayed for review and for auditing and/or analytics purposes.

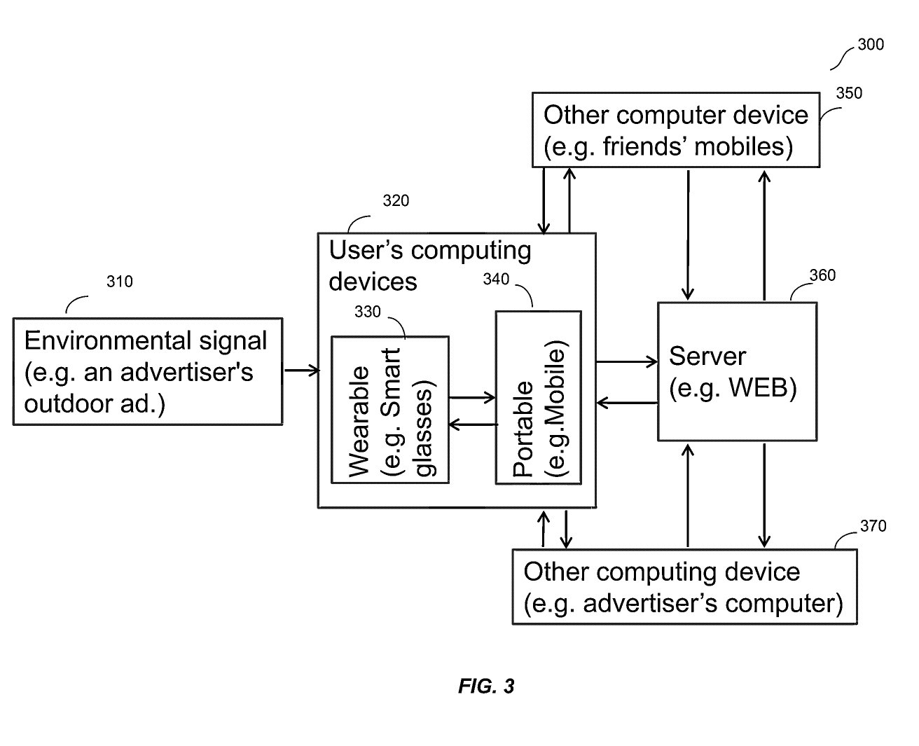

FIG. 3 shows a simple exemplary network of a method in accordance with the present invention. In this network of information, a user of a mobile phone and a wearable device, sends his request to his friends and some advertiser through a real-time connection to the WEB server.

A scenario for this example can be as follows: A smart glasses 330 senses an advertising signal 310, e.g. a restaurant ad., which initiates a user request of checking with friends in 5 minutes. The request is processes by the smart-glasses and since it needs some friends' addresses, it transmits its request to a portable device 340, e.g. a mobile phone. The wearable device prefers the portable device 340 over the WEB server 360, because at the user's location, communicating with the portable device is faster and needs less power. While the mobile phone is sending a request for acceptance message to the friends 350, it also sends a message to the WEB 360 for asking the restaurant for more information, e.g. a menu. Further, server, can get the information and return them back to the user, or user friends for more confirming, until the user makes the last decision.

As an another scenario, the wearable device 330, bypasses the portable device, and directly connects to the WEB 370, because of the user's specific goal to see the reviews for the restaurant in Yelp, without notifying his friends at the first step.

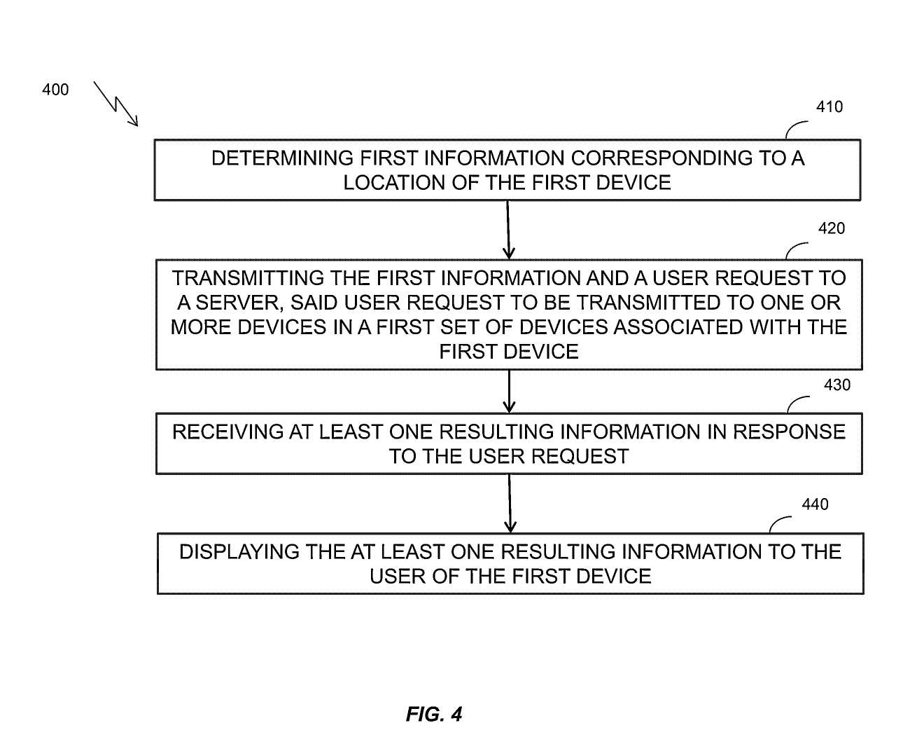

FIG. 4 shows an exemplary operation 400 that may be performed by a portable computing device, in accordance with one embodiment of the present invention. The first computing device receives the primary information from the user and/or his environment.

The first computing device 410 determines a first information corresponding to a location of the first device. Then it transmits 420 the first information and a user request to a server, so that the server correlate the data and based on the result, select some other devices associated with the first device and sends the user request to them. The first computer device also receives 430 the resulting information in response to the user request. Then the first computing device displays the resulting information to the user.

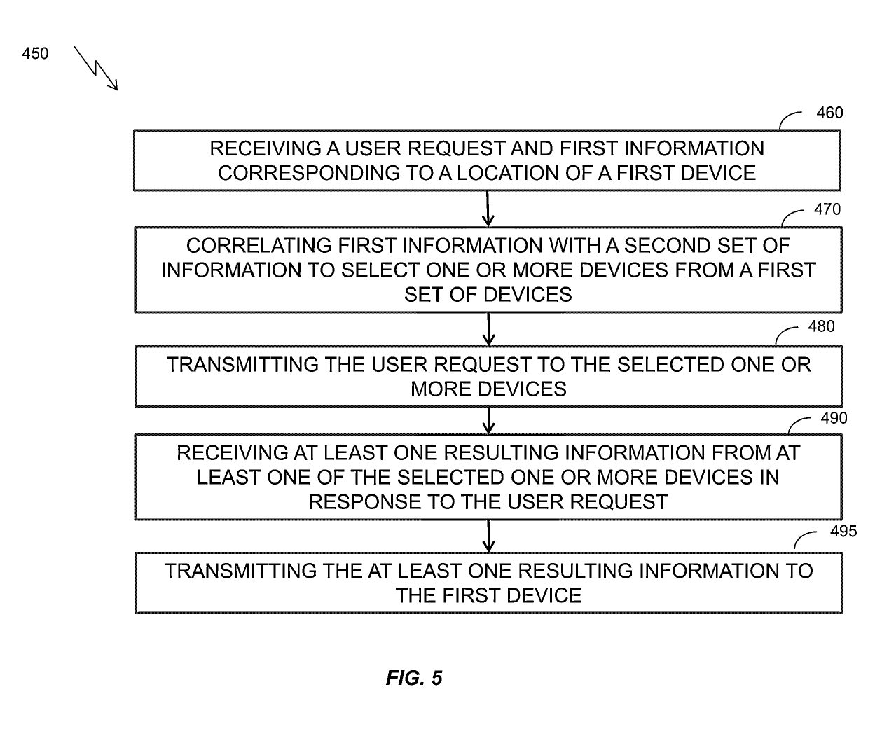

FIG. 5 shows an exemplary operation 450 that may be performed by a server. The server receives 460 a user request and first information corresponding to a location of a first device. Then the server correlates 470 the first information with a second set of information to select one or more devices from a first set of devices. After processing, the server transmits 480 the user request to the selected one or more devices which are associated with the user request and interest. The server receives 490 the some response back from at least one of the selected one or more devices in response to the user request. And then the server transmits 495 at least one of the selected one or more devices in response to the user request.

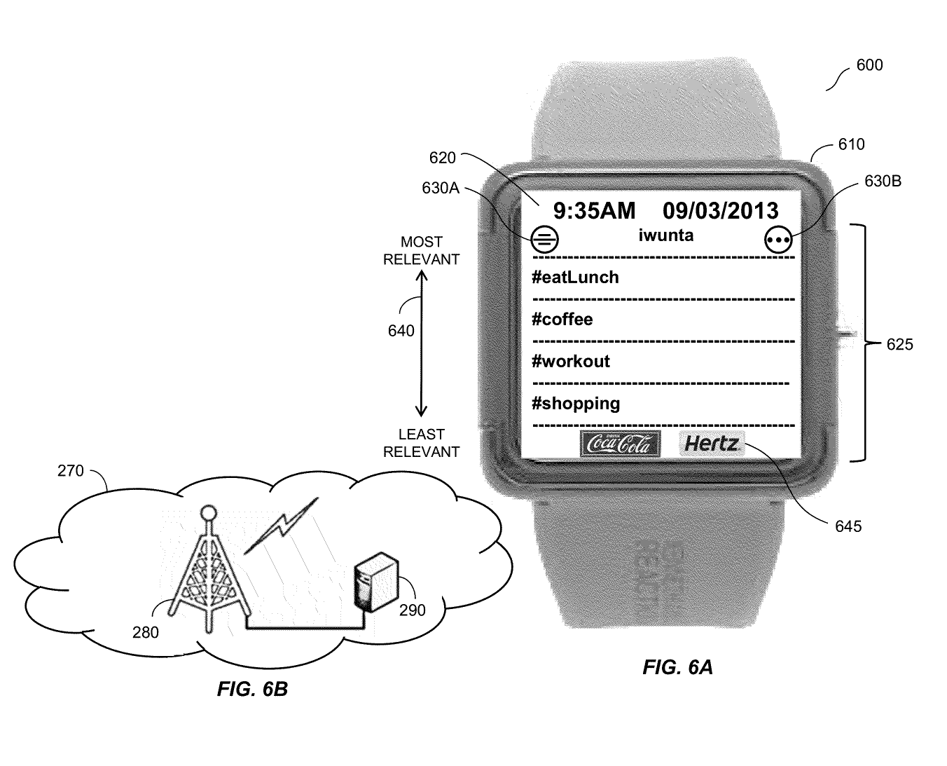

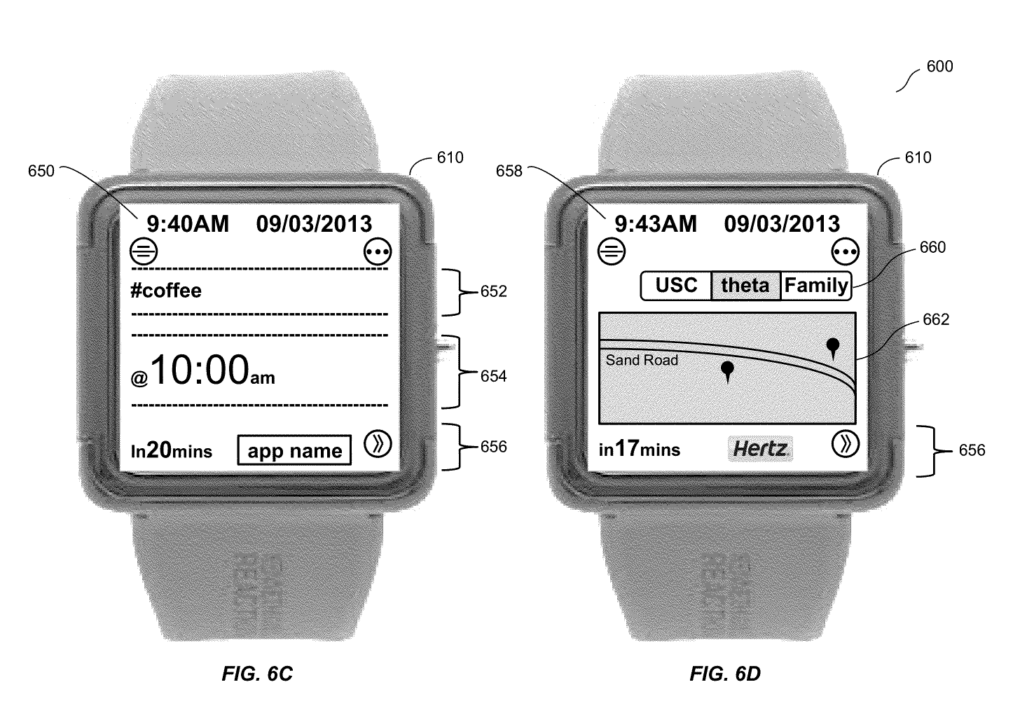

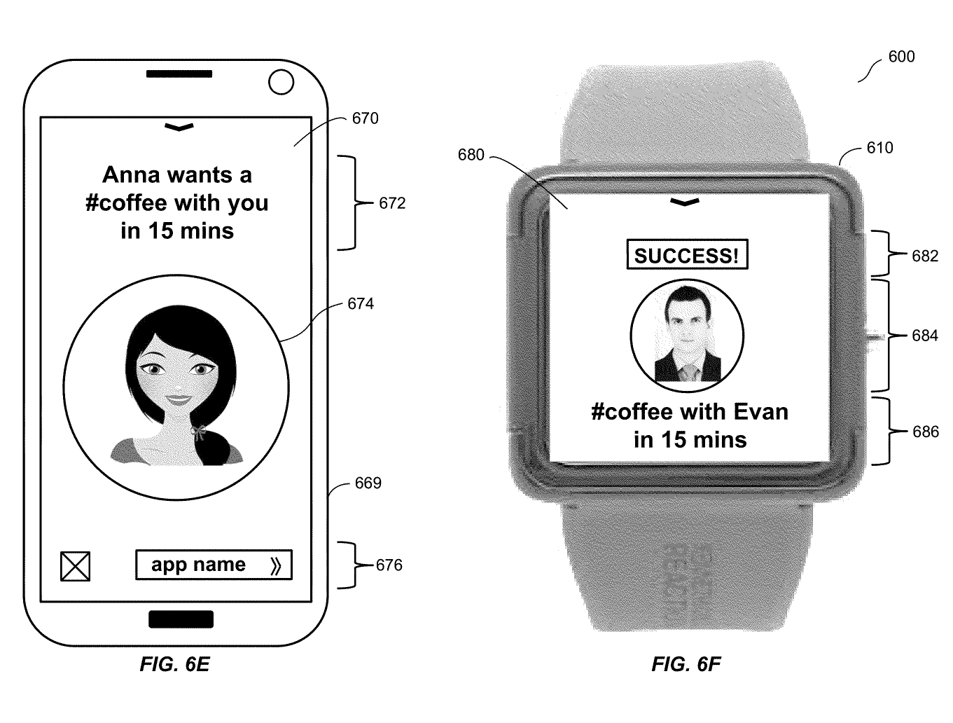

FIGS. 6A-6F depict an exemplary simplified system 600 that may incorporate embodiments of the method depicted in FIG. 1 using a second wearable-computing device 610, in accordance with one embodiment of the present invention. FIG. 6A is a simplified perspective view of second wearable-computing device 610 with an exemplary first visual display output 620, in accordance with one embodiment of the present invention. In this example, second wearable-computing device 610 includes a form factor for a wristwatch, wrist band, smart-watch, or the like, with one or more displays. Second wearable-computing device 610 may include some of the same features as described in reference to the first wearable-computing device 210 depicted in FIG. 2A with the exception that visual display output 620 depicted in FIG. 6A is not transparent so as to be worn over the eyes but is instead worn on the user's wrist.

First visual display output 620 includes a time/date display as would be expected for a watch and a resulting information display area 625. Resulting information display area 625 may include a multitude of display lines, an ad line, and command icons 630A, 630B sent by the data relevance engine to the user's first computing device, e.g. second wearable-computing device 610 in this example. A portion of the multitude of display lines may be associated with a different one of a multitude of interaction options. In one embodiment, the multitude of display lines may be ranked in a list with the most relevant displayed at the top and the least relevant at the bottom as depicted by arrows 640. In an alternative embodiment, the list or group of icons may be displayed in unranked fashion.

In one embodiment, the multitude of display lines in the list may stream continuously updating the resulting information. In one embodiment one of the multitude of display lines may statically display the resulting information until a predetermined time when the data relevance engine determines the resulting information should be updated due to changes in the information inputs. In one embodiment one of the multitude of display lines may be updated periodically with new information. In one embodiment the ranking of the multitude of display lines may be updated dynamically at predetermined times when the data relevance engine determines a new ranking order is appropriate due to changes in the information inputs.

The list of interaction options may correspond to a multitude of activities/requests the user may have predefined in the data relevance engine system that the user wants to share or interact with other users connected to the data relevance engine system, i.e. recipients. In this example, the top line of ranked resulting information display area 625 includes an interaction option for eating lunch. The eating lunch interaction option may have been selected by the data relevance engine as most relevant based on, for example, multiple signals from the user's social network that the user likes to go out to lunch, is presently near an eating establishment frequented by the user in the past, and/or the time is close to lunch time. Thus, the ranking criteria was dynamically analyzed in real-time by the data relevance engine using the sensor data on second wearable-computing device 610, e.g. GPS location.

The next lines down of ranked resulting information display area 625 include text lines for the interaction options for having coffee, going to a workout, and going shopping with the least relevant being the shopping interaction. Each text line may also function as a selection icon, which if tapped by the user, informs the system that the user selects the tapped interaction option. Having coffee may have been selected by the data relevance engine as the second highest ranked interaction option displayed to the user because of previous user history, user's proximity to a coffee vendor previously visited by the user, and/or the mid-morning time.

The bottom line of ranked resulting information display area 625 includes a text line for product or service ads that have been rank selected by the data relevance engine. These ads may be more meaningful than those selected by previous methods because the primary information from the second wearable-computing device 610 provides current geographical location and current user interests in real-time. For example, the second wearable-computing device 610 may be at an airport destination, where a car rental need is likely so an icon for a car rental company ad 645 may be displayed and there is a soft drink dispensing machine nearby so a soft drink ad is displayed. In one embodiment, the audio sensor in second wearable-computing device 610 may have picked up the spoken word “thirsty,” which was analyzed in real-time by the data relevance engine to rank and select the ad category of soft drinks to display.

In one embodiment, second portable computing device 610 provides a method and apparatus for responding to the relevant advertisement by means of touching, gesturing, speaking, moving, or otherwise reacting in relation to portable computing device via sensors therein. In one embodiment, one of the multitude of display lines 625 may include an actionable link and/or one or more interaction options associated with the at least one relevant ad or item on the ranked list. In one embodiment, first visual display output 620 may display a list of ranked or at least one unranked relevant advertisement that the user may select for further action. For example, first visual display output 620 may include a touch sensitive display screen adapted such that the user may select and request additional secondary information associated with the car rental company ad be sent by the system to second portable computing device 610 by touching the icon for the car rental company ad 645.

In one embodiment, a viewer may respond, e.g. trigger an action, by pressing a button on a wearable computing device, motion a body gesture, speaking a voice or sound command, touching a portable computing-device, and/or look or gaze at an object, such as an ad or activity venue. One button may awaken the portable computing-device and confirm to the user which ad the user wished to respond to, then additional inputs (or key presses/touches/sound command inputs) on the device may select additional response options or alternate ads to select and respond to. In one embodiment, multiple levels of nested interactive option menus may be used by the system to navigate complex option decisions. In one embodiment, a user may gesture, for example, wave their hand over the wearable device, or shake the device, or the user may raise his hand or move another body part, e.g. head, in order to trigger the response/reaction to the interactive option.

In one embodiment, a notification, such as a logo bug, a symbol, and/or the like, may be displayed on the portable computing device, for a predetermined period of time near the time when the portable computing device and associated user are in proximity to a predetermined area defined by an ad, an event, a billboard, a merchant location, a sale, a Groupon or similar coupon, a person or friend, and/or the like. The notification may signal to the portable computing device that further information may be now available, which then may signal to the portable computing device that additional options or information are available. The user may then indicate, via a press, a gesture, a voice, a sound input, a touch, or any other form of human-to-device notification, that the portable computing device and associated user requests to see further information, select options, respond to that event or ad, or other respond to the event that the portable computing device was notified of. In one embodiment, the portable computing device may display information such as a brand name, a tagline, a graphical logo, a sound, a voice output description, a light/LED display blink or other light-based indicator, or other means of indication/alert or information, to let the user know that further information is now available. In one embodiment, items are shown which may not be associated to nearby events/merchants/ads, but are presented/displayed/alerted to the portable computing device and user from time-to-time. For example, some alerts/notifications may be sent according to time, user's interests, friends location, and the like.

In one embodiment, a first portable computing device, such as smart glasses may indicate or alert the user that interactive options or actions are available, but the user may press/select/interact with another associated second portable computing device, such as a mobile phone. In other words the portable computing device that indicates or displays the interactive option to the user, may be a different portable computing device than the user responds with. In another embodiment, the portable computing device that indicates or displays the interactive option to the user, may be the same portable computing device than the user responds with.

In one embodiment, the list or group of icons may be adapted to provide the user a way to request from the system particular secondary information related to the selected relevant ad by way of the user selecting one of the one or more interaction options in list or group of icons 655. The system may then transmit the user requested secondary information associated with the selected one of the one or more interaction options to second wearable-computing device 610.

In various embodiments, the one or more interaction options may include a request for additional information, to transmit a rating for the environmental signal, to connect in real-time to the advertiser (such as with a phone-call or video-call), to request email information, to be signed up for a “mailing list” of further information, to select to “like”, or may select to join the relevant Facebook page or twitter or other similar social media mechanism related to that ad or activity venue and/or to be directed or receive navigation information to the merchant associated with the selected ad or where that merchant's product can be purchased or viewed, and the like.

In one embodiment, the one or more interaction options may further include a request to enter into a transaction or potential transaction associated with the information associated with the environmental signal from the sensor associated with first wearable-computing computing device 210 depicted in FIG. 2D. In an alternative embodiment, the environmental signal may be from a sensor associated with second wearable-computing device 610 depicted in FIG. 3A. Accordingly, the information displayed on the portable computing device may be synchronized to any objects, signs, billboard, audio signals, audio ads, ultrasonic information, mobile device ads, laptop ads, desktop ads, magazine ads, LED billboard ads, or any other online or offline ads or information sensed as the environmental signal. Further, such synchronization may be passively accomplished by the system automatically monitoring and acting on the environmental signals in real-time or upon demand by user selection. In various embodiments, the environmental signal may be associated with an advertisement, a venue for an activity, a location of the portable computing device, an orientation of the first portable-computing device (the orientation being associated with a field of view of the user), and/or a movement of the portable computing device.

For example, related to the previously selected icon for the car rental company ad 645, list or group of icons may include icons for the user to request, a display of a map to the nearest office, information for renting a car, a view of current redemption points, rating the environmental signal, which is the ad in this example, and returning back to the previous display screen. In one embodiment the list or group of icons may be displayed in rank order. For example the location of the portable computing device may be determined to be at an airport, determined with high confidence by correlated sensor data received by the portable computing device and transmitted in real-time to the system. The system correlates the user's selection of the car rental ad with the airport location and previous use of that car rental agency to automatically determines that displaying a map to the nearest selected car rental office has highest rank value, renting the car second highest rank value, and so on. In one embodiment, the user and associated portable computing device receives incentives such as redemption points, miles, dollars, contest entrances, discounts, additional discounts, free items, additional items, virtual goods, portions of virtual goods, songs, music, games, apps, videos, and/or the like, and similar such virtual or non-virtual items, for reacting/responding to at least one interactive option.

FIG. 6B is a simplified block diagram of a world-wide-web or cloud network 270 linked to second wearable-computing device 610 represented in FIG. 6A, in accordance with one embodiment of the present invention. The features of FIG. 6B are similar to the features of FIG. 2C and will not be repeated. In this example, the second wearable-computing device 610 is depicted directly communicating with the Internet cloud 270, without the need for another intermediary portable-computing device to be tethered nearby.

FIG. 6C shows a simplified perspective view of second wearable-computing device 610 depicted in FIG. 6A with a second exemplary visual display output 650, in accordance with one embodiment of the present invention. Second exemplary visual display output 650 may include the same features as depicted in FIG. 6A with the following exceptions. Resulting information display area 625 on the touch sensitive screen of second wearable-computing device 610 may include a display of a selected interaction option 652, a selected future time 654 for the selected interaction option 652, and other display lines 656 that may include remaining time until the selected future time 654, an app name or logo, ad, and/or command icons. In one embodiment, second exemplary visual display output 650 may be automatically displayed to the user's first computing device, e.g. second wearable-computing device 610 in this example, by the data relevance engine in the second computing device after the user has made a selection for one of the multitude of interaction option using the first visual display output 620 described above in reference to FIG. 6A.

In one embodiment referring to FIG. 6C, selected interaction option 652 may include one of the one or more interaction options picked by the user and displayed as a reminder, depicting in this example that the user has picked having coffee as the interaction option being requested by the user. Selected future time 654 may include a time in the future selected by the user for engaging in selected interaction option 652. In one embodiment, the display lines may include command icons, that when tapped, inform the system of the command selection entered by the user on a touch sensitive screen. For example, selected future time 654 may be a command icon that when tapped by the user brings up another screen such as a time selection screen (not shown) that allows the user to select any different future time tier the selected interaction option. A command icon on the time selection screen may return the user to the visual display output 650. In other words selected future time 654 displays the meeting time for the selected interaction option 652.

FIG. 6D shows a simplified perspective view of the second wearable-computing device 610 depicted in FIG. 6A with a third exemplary visual display output 658, in accordance with one embodiment of the present invention. Third exemplary visual display output 658 may include the same features as depicted in FIG. 6A with the following exceptions. Resulting information display area 625 on the touch sensitive screen of second wearable-computing device 610 may include a display of at least one or more recipients 660, and/or a map 662. In one embodiment, third exemplary visual display output 658 may be automatically displayed to the user's first computing device, e.g. second wearable-computing device 610 in this example, by the data relevance engine in the second computing device after the user has made a selection for selected future time 654 using the second visual display output 650 described above in reference to FIG. 6C.

In one embodiment referring to FIG. 6D, the at least one or more recipients 660 may have been predefined in the data relevance engine system by the user. The at least one or more recipients 660 may be other users of the system associated with one or more computing devices not being the first computing device. Recall, the first computing device computing device may be located with the user. The at least one or more recipients 660 may be other users that the user of the first and/or third computing device wants to (“iwunta”) share with the experience of the selected interaction option 652. In one embodiment, the at least one or more recipients 660 may be located within a predefined geographic region having a distance predetermined by the user and known in real-time by the data relevance engine.

In one embodiment, the at least one or more recipients 660 may be predefined by the user such that the system automatically sends at least one of the one or more interaction options from the first computing device to the preselected one or more computing devices of the recipients, without the user having to actively make a selection for the recipients. In another embodiment, the user may have predefined the at least one or more recipients 660 to form a list to choose from contemporaneously in real-time when the selection of the interaction option is made by the user and before the interaction option request is sent out to the recipients. In other words, the at least one or more recipients 660 may be displayed on third visual display output 658 as selectable command icons that when tapped by the user inform the system which one or more computing devices not being the first computing device are selected by the user to receive the interaction option invitations/requests. In this example, the at least one or more recipients 660 may include a multitude of preselected recipients associated with three categories of recipients including the user's school, e.g. the University of Southern California (USC), the user's fraternity or club, e.g. the theta fraternity, and/or the user's family. In this example, the user has selected the user's fraternity, theta, which may be displayed as highlighted. In one embodiment, other display screens (not shown) may be displayed on the user's first computing device by which the user is provided command icons and text input so as to set up or predefine the user's recipients and recipient categories.

In one embodiment, map 662 may include a geographic display including the location of the selected one or more computing devices not being the first computing device, i.e. the selected recipients, within a predefined distance from the location of the first computing device, i.e. the user. Map 662 may thus provide the user with information such as the number and/or identities of potential recipients for a selected category of recipients before the system sends out the invitation/request to help the user make a selection of the at least one or more recipients 660.

FIG. 6E shows a simplified front view of a recipient's portable computing device 669, similar in function to portable computing device 250 depicted in FIG. 2B with an exemplary visual display output 670, in accordance with one embodiment of the present invention, after the at least one of the one or more interaction options from the first computing device is sent to the selected one or more computing devices not being the first computing device via the second computing device, i.e. the data relevance engine. Visual display output 670 may include a text invitation 672, a visual image 674 associated with the first computing device, e.g. a picture associated with the user, and/or the other display lines 676 that may include remaining time until the selected future time 654, an app name or logo, ad, and/or command icons. Text invitation 672 may include the name of the requestor, i.e. the user originally sending the interaction option request, the selected interaction option to be shared, and the selected future time when the interaction option is to be shared. Other display lines 676 may include a command icon to reply to the sent request to accept or deny the request, which may be sent back to the data relevance engine in the second computing device.

FIG. 6F shows a simplified perspective view of the second wearable-computing device 610 depicted in FIG. 6A with a fourth exemplary visual display output 680, in accordance with one embodiment of the present invention, after acceptance or denial of the request from the recipients is received by the second computing device and sent to the first computing device. Fourth exemplary visual display output 680 may include a status indicator for the request 682, a visual image 684, and an text confirmation 686. Status indicator for the request 682 may indicate the requested invitation was successfully accepted by at least one of the selected one or more computing devices not being the first computing device, or alternatively, indicating requested invitation was regrettably denied by all the selected one or more computing devices not being the first computing device. Visual image 684 may be associated with at least one of the selected one or more computing devices not being the first computing device, i.e. a picture associated with the replying recipient. Text confirmation 686 may include the name of the replying recipient, the selected interaction option to be shared, and the selected future time or time remaining until the selected future time when the interaction option is to be shared.

Referring simultaneously to FIG. 1, receiving 160 real-time events data, such as stock movements, social media posts, sports updates, and the like, includes accessing 160 external information. Correlating and determining a resulting information step 150 includes the following operations. The incoming real-time events data and advertiser information are categorized 185. In one embodiment, the categorizing 185 may use a Bayesian classifier, which uses probabilistic statistical technique to minimize the probability of misclassification by using training data to learn over time how to classify the incoming real-time events data and advertiser information correctly. In one embodiment, the categorization of the multitude of incoming real-time events data and advertiser information is used to create a list of interaction options relevant in real-time to the user. In one embodiment, the categorization of the multitude of incoming real-time events data and advertiser information is used to create a multitude of information display types, such as sports scores, local information such as movie times, local merchant sales information, and the like. In one embodiment the multitude of information display types may be displayed to the user in either different locations within a display, or are rotated/displayed to the user over time, e.g. audio streamed in user interest ranking order.

Correlating and determining a resulting information step 150 receives the user's portable real-time device sensor data, e.g. audio, video, location, time, and device information associated with steps 115, 120, 125, and 130 respectively. In one embodiment, the sensor's data may be assigned a numerical weighting with the purpose of giving that sensor's data a relative importance. The numerical weight assigned to any given data input is referred to as the RankWeight for that sensor type. This ranking is not the only algorithm that determines rankings in the output results, but merely one of many factors used to determine ranking of input data at any given time. The RankWeight may be static or dynamic, and may be different for different types of sensors, users, or other factors. In one embodiment, more recent primary sensor data, such as voice recognized words for example, may be weighted more heavily, e.g. more relevant, than older data.

The received sensor data and the classified real-time events data and advertiser information is used to estimate 190 relevance or user interest for the data in real-time. In one embodiment the resulting information may be ranked by a weighted sum approach, or Eigen-vector approach. In another embodiment, collaborative filtering is used to automatically estimate the relevance for the data. For example, data may be assigned a predicted weight factor, e.g. filtering, based on matching a multitude of recommendations, e.g. collaboration, from social media friends for data that the user of the portable-computing device has not directly rated. Collaborative filtering leverages the extensive data input from social media and the other extensive secondary data sources that are input to the data relevance engine with high statistical confidence. Therefore, the categorizing 185 incoming data and estimating 190 relevance corresponds to correlating the primary, e.g. environmental sensor information in real-time with secondary information associated with the user's interest to form the correlated data. Next, the relevance weighted correlated data is sorted 195 by likelihood of relevance to form the resulting information as a ranked list of interaction options, events, information, and/or ads. In other words the sorting 195 determines the resulting information. The resulting information includes a plurality of real-time information ranked by the user interest and responsive to the first information, which are transmitted 170 from the data relevance engine and received by the user's portable-computing device 115 or 130 in real-time. The resulting information may further include the one or more interaction or interactive options described previously as a ranked or unranked list of events, options, and/or ads.

Below several example of formulas demonstrate how to calculate weighted averages which serves as an element in calculating a point-based total. The weighted mean is similar to an arithmetic mean, e.g. the most common type of average, where instead of each of the data points contributing equally to the final average, some data points contribute more than other data points. The notion of weighted mean plays a role in descriptive statistics and also occurs in a more general form in several other areas of mathematics.

Formally, a weighted mean of a non-empty set of data {x₁, x₂, . . . , x}, with non-negative weights {w₁, w₂, . . . , wₙ}, can be written as follows:

$$\overline{x} = \frac{{\sum }_{i = 1}^{n} {w}_{i} {x}_{i}}{{\sum }_{j = 1}^{n} {w}_{i}} , \\ or$$

$$\overline{x} = \frac{{w}_{1} {x}_{1} + {w}_{2} {x}_{2} + … + {w}_{n} {x}_{n}}{{w}_{1} + {w}_{2} + … + {w}_{n}} .$$

Therefore, data elements with a high weight contribute more to the weighted mean than do elements with a low weight. The weights cannot be negative. Some may be zero, but not all of them (since division by zero is not allowed).

The formulas are simplified when the weights are normalized such that they sum up to one (e.g., Σ_{1,i.e.i=1}ⁿ wᵢ=1). For such normalized weights, the weighted mean can be written as follows:

$$\overline{x} = {\sum }_{i = 1}^{n} {w}_{i} {x}_{i}$$

Note that one may normalize the weights by making a transformation on the weights such that

$${w}_{i}^{′} = \frac{{w}_{i}}{{\sum }_{j = 1}^{n} {w}_{j}} .$$

Using the normalized weights yields the same results as when using the original weights. Indeed,

$$\overline{x} = {\sum }_{i = 1}^{n} {w}_{i}^{′} {x}_{i} = {\sum }_{i = 1}^{n} \frac{{w}_{i}}{{\sum }_{j = 1}^{n} {w}_{j}} {x}_{i} = \frac{{\sum }_{i = 1}^{n} {w}_{i} {x}_{i}}{{\sum }_{j = 1}^{n} {w}_{j}} = \frac{{\sum }_{i = 1}^{n} {w}_{i} {x}_{i}}{{\sum }_{i = 1}^{n} {w}_{i}} .$$

The common mean

$$\frac{1}{n} {\sum }_{i = 1}^{n} {x}_{i}$$

is a special case of the weighted mean where all data have equal weights, wᵢ=w. When the weights are normalized, then

$${w}_{i}^{′} = \frac{1}{n} .$$

To take into account variance, the weighted mean of a list of data for which each element xᵢ comes from a different probability distribution with known variance σᵢ², one possible choice for the weights may be written as follows:

$${w}_{i} = \frac{1}{{σ}_{i}^{2}} .$$

The weighted mean may then be written as follows:

$$\overline{x} = \frac{{\sum }_{i = 1}^{n} ( {x}_{i} {w}_{i} )}{{\sum }_{i = 1}^{n} {w}_{i}} ,$$

and the variance of the weighted mean may be written as follows:

$${σ}_{\overline{x}}^{2} = \frac{1}{{\sum }_{i = 1}^{n} {w}_{i}} ,$$

which reduces to

$${σ}_{\overline{x}}^{2} = \frac{{σ}_{0}^{2}}{n} ,$$

when all σᵢ=σ₀.
The significance of this choice is that this weighted mean is the maximum likelihood estimator of the mean of the probability distributions under the assumption that they are independent and normally distributed with the same mean.

### Vector-Valued Estimates:

As in the scalar case, the weighted mean of multiple estimates can provide a maximum likelihood estimate. For vector-valued estimates, σ² may be replaced by the covariance matrix, as follows:

Wᵢ=Σᵢ⁻¹.

The weighted mean may be written as follows:

$$\overline{x} = {( {\sum }_{i = 1}^{n} {Σ}_{i}^{- 1} )}^{- 1} ( {\sum }_{i = 1}^{n} {Σ}_{i}^{- 1} {x}_{i} ) ,$$

and the covariance of the weighted mean may be written as follows:

$${Σ}_{\overline{x}} = {( {\sum }_{i = 1}^{n} {Σ}_{i}^{- 1} )}^{- 1} ,$$

For example, consider the weighted mean of the point [1 0] with high variance in the second component and [0 1] with high variance in the first component. Then

$${x}_{1} = {[ 10 ]}^{T} , {Σ}_{1} = [ \begin{matrix}1 & 0 \\ 0 & 100\end{matrix} ]$$

$${x}_{2} = {[ 01 ]}^{T} , {Σ}_{2} = [ \begin{matrix}100 & 0 \\ 0 & 1\end{matrix} ] ,$$

Then, the weighted mean may be written as follows:

$$\begin{matrix}\overline{x} = {( {Σ}_{1}^{- 1} + {Σ}_{2}^{- 1} )}^{- 1} ( {Σ}_{1}^{- 1} {x}_{1} + {Σ}_{2}^{- 1} {x}_{2} ) \\ = [ \begin{matrix}0.9901 & 0 \\ 0 & 0.9901\end{matrix} ] [ \begin{matrix}1 \\ 1\end{matrix} ] \\ = [ \begin{matrix}0.9901 \\ 0.9901\end{matrix} ] ,\end{matrix}$$

in this case, the [1 0] estimate is “compliant” in the second component and the [0 1] estimate is compliant in the first component, so the weighted mean is nearly [1 1].

Another method of calculation takes into account correlations between data elements. In the general case, suppose that X=[x₁, . . . , xₙ], C is the covariance matrix relating the quantities xᵢ, x̅ is the common mean to be estimated, and W is the design matrix [1, . . . , 1] (of length n). The Gauss-Markov theorem states that the estimate of the mean having minimum variance is written as follows:

σ _{x̅}²=(W^{T}C⁻¹W)⁻¹,

and

x̅=σ _{x̅}²(W^{T}C⁻¹X).

Consider the time series of an independent variable x and a dependent variable y, with n observations sampled at discrete times tᵢ. In many common situations, the value of y at time tᵢ depends not only on xᵢ but also on its past values. Commonly, the strength of this dependence decreases as the separation of observations in time increases. To model this situation, one may replace the independent variable by its sliding mean z for a window size m, as follows:

$${z}_{k} {\sum }_{i = 1}^{m} {w}_{i} {x}_{k + 1 - i} ,$$

In the scenario described in the previous section, most frequently the decrease in interaction strength obeys a negative exponential law. If the observations are sampled at equidistant times, then exponential decrease is equivalent to decrease by a constant fraction 0<Δ<1 at each time step. Setting w=1=Δ, in normalized weights can be defined as follows:

$${w}_{i} = \frac{{w}^{i - 1}}{{v}_{1}} ,$$

where V₁ is the sum of the un-normalized weights. In this case V₁ can be written as follows:

$${V}_{1} = {\sum }_{i = 1}^{m} {w}^{i - 1} = \frac{1 - {w}^{m}}{1 - w} ,$$

In this case, V₁ approaches V₁=1/(1−w) for large values of m.

The damping constant w corresponds to the actual decrease of interaction strength. If this cannot be determined from theoretical considerations, then the following properties of exponentially decreasing weights are useful in making a suitable choice: at step (1−w)⁻¹, the weight approximately equals to e⁻¹(1−w)=0.39 (1−w), the tail area approximately equals to e⁻¹, the head area approximately equals to 1−e⁻¹=0.61. The tail area at step n is ≦e^{-n(1-w)}, where primarily the closest n observations matter and the effect of the remaining observations can be ignored safely. Then the damping constant w may be chosen such that the tail area is sufficiently small. It should be noted that the weight calculation methods described above are mere examples, and any other weight calculating and/or ranking method may be used without departing from the teachings of the present disclosure.

In one embodiment, the user may provide active feedback 170 via the portable-computing device. Active feedback 170 may include explicit user feedback, e.g. thumbs-up or thumbs-down, and/or user notifies the system by choosing or declining a displayed interactive option. Active feedback 170 may further include implicit user feedback based for example on the user purchasing an advertised product or service. An example of implicit user feedback may be the user buys the product or service or visits a vendor or service venue. The user may transmit 105 the interaction option selected by the users from the first computing device to the data relevance engine in the second computing device. The user's request 105 is received and stored by the data relevance engine and is input to estimating 190 the relevance of the one or more interaction options. User interest data may further include historical information, which may be heavily weighted to prefer recent data. Historical information may include prior purchases, location destinations, and the like. In one embodiment, a user's feedback or selections are used to modify/change the weightings of that user's later displayed resulting information. In one embodiment, relevance outputs can be weighted by a user's stated, e.g. explicit user feedback, or detected, e.g. implicit user feedback interests. For example, twitter #hashtags, Facebook Likes, recent social media or email data, a user's friend's Facebook postings, and the like.

In one embodiment, the data relevance engine may sort the recipients selected by the user according to the real-time geographical location of the recipients and the preselected distance between the first computing device and the selected one or more computing devices not being the first computing device, i.e. the recipient's computing devices. In one embodiment, the data relevance engine may transmit real-time geographical location data of the selected one or more computing devices not being the first computing device sorted by real-time geographical location of the recipients such that only locations of recipients within a predetermined distance to the first computing device is transmitted to the first computing device.

In one embodiment, the data relevance engine may send 180 the interaction request to the geographically sorted selected recipients and/or friends. The sorted selected recipients and/or friends' responses to accept or deny the request are transmitted 135 to and received by the data relevance engine as described above.

In one embodiment, the sensor information received (115, 120, 125 or 130) from the first computing device may be optionally directed directly to active feedback 170 bypassing the real-time correlation 150 in the data relevance engine. In one embodiment, the sensor information received (115, 120, 125 or 130) from the first computing device may be optionally directed directly to implicit user feedback 170.

In one embodiment, when the primary sensor information is continuously transmitted, the data relevance engine may continuously and/or passively monitor or “listen”, decode using voice recognition, and correlate words or phrases in conversation within hearing distance of the portable-computing device, to provide real-time user interest information associated with those “heard” words. For example, if the microphone input of the portable-computing device hears the word “hungry”, the data relevance engine may automatically display a distance to a restaurant that serves food that is of interest to the user. In another embodiment, when the primary sensor information is continuously transmitted, the data relevance engine may continuously and/or passively monitor, decode and correlate captured video or periodically sampled static visual images in the line-of-sight of the portable-computing device, to provide real-time user interest information. In one embodiment, the decoded video or camera image data may include decoded text key words or symbols associated with advertising.

In one embodiment, data such as #hashtags associated with a user's interests, or in another example a list of “likes” associated with a user's interests, are used to correlate and weight data inputs. For example, if a user's wearable-computing device recognizes (passively or actively) the words “Italian,” then one such resulting output streams may be Italian restaurants in the local area.

In one embodiment, the weighting of the ranking is influenced by other relevant recipients' prior selections. Other relevant recipients may include recipients other than the user who may be nearby, friends, or anyone else. Such ranking may be further ranked according to the other relevant person's “distance”, e.g. geographic distance, social graph distance, and/or the like, from the user. In one embodiment, tweets, Facebook posts, and other social media or blog or related posts (entries) are used as inputs into the data relevance engine

In one embodiment, the resulting information may not necessarily be displayed or immediately displayed or displayed on the same device. A first portion of the multitude of resulting information may be displayed on a first portable-computing device, while a second portion different than the first portion may be displayed on a second portable-computing device different from the first portable-computing device.

In one embodiment, pictures and any resulting text or other data extracted data, e.g. facial recognition/identification of recipients captured by the sensors on the user's portable-computing device may be used as primary inputs into the real-time relevance engine. In one embodiment, data from the sensors on the user's portable-computing device are combined/correlated with sensor input data from nearby other sensors, e.g. other user's sensor's data, nearby fixed sensor inputs, to increase the confidence of the rank weighting of that sensor's data. This combined/correlated sensor data may both increase the confidence of the sensor input when two different nearby sensors are sensing the same inputs, or could decrease the confidence when two nearby sensors are detecting different information.

In one embodiment, an intention detection output from the data relevance engine may be calculated based on a weighted input of factors including; a) real-time location sensor data, e.g. what shopping district the portable-computing device and user are in, b) place of business, e.g. what specific store the portable-computing device is in, and c) detected items, e.g. what product packaging that the portable-computing device is seeing in real-time. In one embodiment, real-time analytics are output from the data relevance engine. Such analytics and/or “intention detection” outputs may be used for optimally relevant advertisement selection.

In one embodiment, the multitude of sensor and non-sensor inputs are cross-correlated to confirm real-time relevance, e.g. improving signal to noise ratio. For example, an audio input, e.g. when the phrase “all passengers to gate 70” is registered by the data-relevance engine then user's portable-computer device is likely at an airport, may be correlated with a GPS location input, which also indicates the user's portable-computer device is at an airport, then relevancy to an airport location is further confirmed. In one embodiment, further data may be inferred from other sensor data. For example, a real-time speed may be inferred from the GPS location sensor data. In one embodiment, sensor data, e.g. audio inputs and resulting voice recognition words, associated with a GPS location may be stored and correlated with that GPS location as historical data, such that when another or figure user's portable-computer device may be at that same location in the future, then the prior audio input voice recognized words may be used for further relevance inputs or weighting. Such historical data may be discounted by time, e.g. age of the historical data.

In one embodiment, the list of a viewer's soon-to-be, currently-seen, or recently-seen advertisement list is ranked according to various criteria such as advertiser's fee rate, time since viewer was likely impressed/impacted by that ad, relevancy of that advertisement to the user's predicted or historical interest, and/or other criteria.

In one embodiment, a user selects one or more items, i.e. interaction options, being wants, desires, intents, needs, requests, or invitations via the first computing device. The user may select or enter one or more items via direct text entry, voice entry (coupled with a voice recognition system), via selecting from a list, via selecting from a list of the user's prior selected items (and optionally ranked via frequency, recent, and the like), from a list automatically created by time of day/day of week (i.e. lunch items may appear during certain local-time hours, dinner items would appear only dinner time, and the like), from a list automatically created based on one or more other recipients' listed items, prior selected or entered items, or from similar other item selection/entry means.

In one embodiment, after the user enters or selects his wants, desires, intents, needs, and/or requests, then the system selects a target list of recipients to whom the user or the system may transmit information. This information may include information about the user including but not limited to the user's name, one or more pictures, one or more videos, age, location, social network information, social group information, prior transmitted information history, prior acceptance information/history information, prior “acceptance” information, prior “showed up” history, friend ratings, time of request, and/or other similar information. The target list of recipients may be gathered and/or then filtered based on the potential recipient's geographical distance to user, social network distance of the user (one friend-of-friend away, two friends-of-friends away, and the like), shared friends, shared region (i.e. both the recipient and the user are both currently on-campus USC students), shared affiliations (i.e. both the recipient and the user are both members of the Alpha-Beta fraternity), and the like. The filtering/ranking of which the targeting of the recipients may be manually controlled/selected by the user or may be fully or partially automatically selected. Recipients may filter the types/distances/criteria/all/none/ads on/ads off/money saving only offers/group of friends/VIPs only that they wish to receive information/invites/ads/offers from. The system, based on the targeted recipient list, then transmits the information to the recipient.

In one embodiment, one or more recipients can then “accept” (confirm/agree to) the information (e.g. go for coffee in 5 minutes). That acceptance may be via a user's wearable or other portable computing device or laptop/desktop computing device. Methods of acceptance include clicking, gesturing, voice inputs, speaking, touching, moving, physical motion, eye gazing, and other user input methods.

In one embodiment, the information (invitation) may be limited to only one/the first recipient to accept, while in other embodiments the information (invitation) may be open to up to a specified number of recipients (#invitation for up to 4 recipients to join tier dinner in 10 minutes), or to an unlimited number of recipients.

In one embodiment, the information (invitation) may be time limited (has an expiration time/date) or may be for an unlimited amount of time.

In one embodiment, the information (invitation) may be targeted to only specific types of recipients (i.e. females only) or according to one or more specific criteria (only recipients on user's Facebook friends list, under 25 years old, and the like).

In one embodiment, the information (invitation) may be targeted to only specific locations of recipients (i.e. within 3 miles of user's current GPS location only) or according to one or more specific geographic criteria (only recipients within user's zip code, city, state, country, and/or the like).

In one embodiment, the information (invitation) is routed to an offer/ad engine that computes and delivers back to the user and/or the recipients (who have accepted or not accepted) an ad or offer. This ad or offer may be targeted specifically for the invitation type (i.e. #coffee), and may be matched/customized according to the time/date (i.e. store open hours), user's and/or recipient's location (distance between the merchant and the user), number of accepted recipients, whether that user/recipients prior ad/offer acceptances or other criteria (age/sex/and/or the like), device type (i.e. wearable vs. mobile phone device, model number, screen size, and the like),

In one embodiment, a tiered/delayed sequence of recipients in “waves” may be sent in order to reach out first to a prioritized sequence of recipients/groups/types first, followed later by additional waves of lower prioritized recipients/groups/types. In one example sequence, first a list of only “close friend” recipients is sent, then a pause (i.e. several minutes delay) before the second wave of recipients is targeted. A second wave of recipients may include less-close friends, followed later by a later third-wave of “anyone (public) within a geographical range. The waves may also be targeted sequences of waves based on geographic distance—for example the first wave of targeted recipients may be selected to be targets within close range (i.e. Within 500 feet near me), followed shortly thereafter by a second wave of targets at further range (i.e. Within 2000 feet of me), and the like. The point here being to offer closer/higher priority recipients prioritized access sooner than lower priority recipients.

In one embodiment, a user's ads and/or offers are determined in accordance with time, likelihood of interest, acceptance by other (closer or far) users, popularity of the offer, other user feedback/ratings, local feedback, non-local (national) feedback, and the like.

In one embodiment, a user's ads and/or offers are determined according to various criteria such as advertiser's tee rate, time since viewer was likely impressed/impacted by that ad, relevancy of that advertisement to the user's predicted or historical interest, and other criteria.

In one embodiment, a user may be presented with a list of advertisements (ranked or unranked) that the user can select for further action—for example to receive more information about that product, or to connect in real-time (for example a phone call) to that advertiser, to request email information, to be signed up for a “mailing list” of further information, to receive directions (navigation) to that merchant or where that merchant's product can be purchased at or viewed, and the like.

In one embodiment, a viewer may respond (trigger an action) by means of pressing a button on a wearable computing device, motion a body gesture, via speech, or pressing a button or touching a non-wearable-computing-device (i.e. a mobile phone or tablet). One button may awaken the device and confirm to the user which ad to which the user wished to respond to, then additional inputs (or key presses) on the device could select additional response options or alternate ads to select and respond to.

In one embodiment, a minimum number of acceptances by recipients might be required to trigger the overall acceptance. For example, a certain discount might be available for only 4 or more recipients—i.e. 20% of movie tickets for groups of 4 or more recipients, or buy 2 coffees, get a 3rd coffee for free.

In one embodiment, the invitation list may be preceded with a hash “#” symbol, indicating the wording following the hashtag as an interest/category/subject, for example #coffee #dinner #movie #actionmovie #workout. The hashtag may optionally be used to group related requests together as convenience for the user, such as viewing a list of friends who have expressed interest in seeing a movie via using the hashtag #movie.

In one embodiment, the invitations may be sent to recipients already signed onto the system and/or to recipients signed on to related systems (e.g. Facebook, LinkedIn, and the like), or sent to other receipts known to the user (in his phone, cloud, skype, or other address/contact book). Certain recipients may be sent via the system itself (apps, HTML5 apps, backend database, servers, and the like), via an advertiser's own communication systems or channels, or sent via other communication systems such as TXT/SMS messaging systems, or via other messaging systems such as Facebook messages, Apple Messenger, Skype messaging, and the like.

In one embodiment, an ad/offer may contain “navigate to this merchant” information, which could activate a user's GPS or other navigation system to help the user get to the merchant.

In one embodiment, an ad/offer may contain a “Like” (via Facebook) for this merchant, or thumbs up/down buttons, allowing the user to indicate to the system that he is or is not interested in this type of ad/offer. The system would then take that user feedback into consideration to prioritize/select future-sent ads/offers to that specific (or related) users.

In one embodiment, the information (invitation) may be sent from computing devices other than wearable devices, including laptop and desktop computers, and/or from desktop-accessed websites such as Facebook.com, Twitter.com, LinkedIn.com, and the like.

In one embodiment, the information (invitation) may be received through an operating-system level integration (such as Apple notifications), installed-software level integration (such as Growl notifications), web-based integration (such as Facebook notifications), and the like.

In one embodiment, distance-based targeting of the information (invitation) may be filtered based on real-time or historical date including traffic conditions, weather conditions, population density, time of day, day of the week, if the user is currently driving (determined by accelerometer and/or GPS) and the like.

In one embodiment, distance-based targeting of the information (invitation) may be filtered based on the time and/or duration of the event, such that the distance calculation is modified by the start time of the event and/or the duration of the event, which is determined either by user input or other means (such as pulling data from notifications of the event on websites such as Ticketmaster, Facebook, and the like).

In one embodiment, user location is determined by cell tower information, nearby WiFi signals, and/or other low-powered means. If the user is near the boundary of maximum distance for the information (invitation), then the portable or wearable computing device uses GPS or one or more other higher-powered signal (either separately or in conjunction with each other and/or the low-powered location sensor) to obtain a more accurate reading, thereby placing the user inside or outside the acceptable distance for the information (invitation). If the sensor reports low accuracy in determining distance, then this triggers higher-powered location sensing.

In one embodiment, accepting information (invitation) places a user in a group chat with other users who are also invited to and/or participating in the information (invitation). This group chat may then be used as another vehicle for ads (e.g. sponsored chat messages, or a banner ad that recommends a place to go based on factors including distance, store hours, price sensitivity of group, past locations visited, online reviews, social data, advertiser fee paid to service, and the like.)

In one embodiment, the user may be notified of only accepted invitations, that is, showing the user only positive feedback. In one embodiment, the interaction option contains a time duration. In one embodiment, the interaction option is to Like the person or service associated with the first information. In one embodiment, an advertisement/offer is transmitted to the first device. In one embodiment, the interaction option is to enter into a transaction or potential transaction associated with the first information.

In one embodiment, user sends interaction option. Server pings mobile device of recipients (sorted in accordance with past location history or other factors) with a request for recipients' current location. Recipients' device responds with recipients' current geographic location. Server determines which recipients' are geographic close and sends invitations to geographic close recipients'.

In one embodiment, the user sends interaction option(s) to at least one additional user. The server pings the mobile device(s) of recipients, where the ping/request itself contains the current location of the user that sent the interaction option. Recipients' devices that respond are considered to be nearby the user's first computing device (may or may not transfer other users' locations). In this example, distance from the user may be calculated on the computing devices themselves or on paired devices. The reverse could also be true: every device that responds is considered to be far away. Recipients' devices may not respond to the server at ail, instead deciding themselves whether to show the invitation. Upon accepting/rejecting the invitation, then the devices respond, or the devices may only respond when either accepting (opt-in) or rejecting (opt-out).

In one embodiment, advertisements and offers are responded to by electronically communicated intents, desires, requests and messages transmitted to a socially-limited or a geographical-limited group of recipients.

FIG. 5 shows a simplified block diagram of a computer system that may incorporate embodiments of the present invention. FIG. 5 is merely illustrative of an embodiment incorporating the present invention and does not limit the scope of the invention as recited in the claims. One of ordinary skill in the art would recognize other variations, modifications, and alternatives.

In one embodiment, computer system 700 typically includes a monitor or 710, a computer 720, user output devices 730, user input devices 740, communications interface 750, and the like. Computer system 700 may also be a smart phone, tablet-computing device, and the like, such that the boundary of computer 720 may enclose monitor or graphical user interface 710, user output devices 730, user input devices 740, and/or communications interface 750 (not shown).

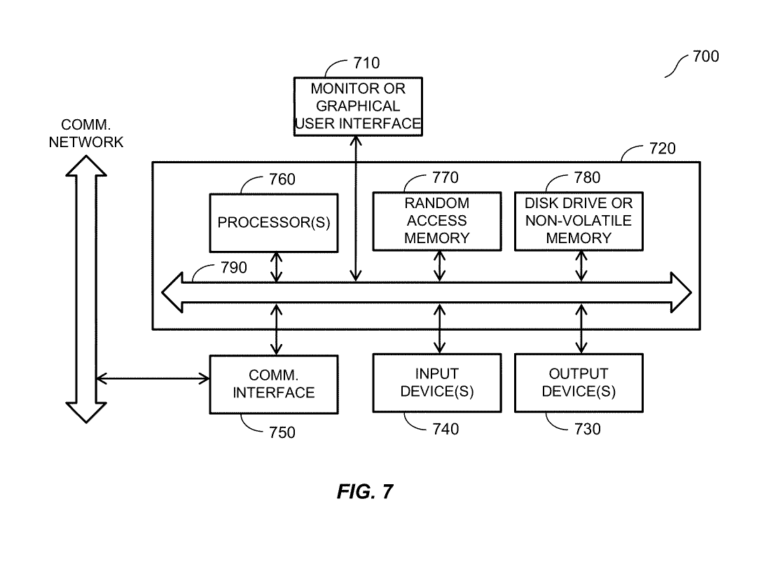

As depicted in FIG. 7, computer 720 may include a processor(s) 760 that communicates with a number of peripheral devices via a bus subsystem 790. These peripheral devices may include user output devices 730, user input devices 740, communications interface 750, and a storage subsystem, such as random access memory (RAM) 770 and disk drive or non-volatile memory 780.

User input devices 730 include all possible types of devices and mechanisms for inputting information to computer system 720. These may include a keyboard, a keypad, a touch screen incorporated into the display, audio input devices such as voice recognition systems, microphones, and other types of input devices. In various embodiments, user input devices 730 are typically embodied as a computer mouse, a trackball, a track pad, a joystick, wireless remote, drawing tablet, voice command system, eye tracking system, and the like. User input devices 730 typically allow a user to select objects, icons, text and the like that appear on the monitor or graphical user interface 710 via a command such as a click of a button, touch of the display screen, or the like.

User output devices 740 include all possible types of devices and mechanisms for outputting information from computer 720. These may include a display (e.g., monitor or graphical user interface 710), non-visual displays such as audio output devices, and the like.

Communications interface 750 provides an interface to other communication networks and devices. Communications interface 750 may serve as an interface for receiving data from and transmitting data to other systems. Embodiments of communications interface 750 typically include an Ethernet card, a modem (telephone, satellite, cable, ISDN), (asynchronous) digital subscriber line (DSL) unit, FireWire interface, USB interface, and the like. For example, communications interface 750 may be coupled to a computer network, to a FireWire bus, or the like. In other embodiments, communications interfaces 750 may be physically integrated on the motherboard of computer 720, and may be a software program, such as soft DSL, or the like. Embodiments of communications interface 750 may also include a wireless radio transceiver using radio transmission protocols such as Bluetooth®, WiFi®, cellular, and the like.

In various embodiments, computer system 700 may also include software that enables communications over a network such as the HTTP, TCP/IP, RTP/RTSP protocols, and the like, alternative embodiments of the present invention, other communications software and transfer protocols may also be used, for example IPX, UDP or the like.

In some embodiment, computer 720 includes one or more Xeon microprocessors from Intel as processor(s) 760. Further, one embodiment, computer 720 includes a UNIX-based operating system. In another embodiment, the processor may be included in an applications processor or part of a system on a chip.

RAM 770 and disk drive or non-volatile memory 780 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 770 and disk drive or non-volatile memory 780 may be configured to store the basic programming and data constructs that provide the functionality of the present invention.

Software code modules and instructions that provide the functionality of the present invention may be stored in RAM 770 and disk drive or non-volatile memory 780. These software modules may be executed by processor(s) 760. RAM 770 and disk drive or non-volatile memory 780 may also provide a repository for storing data used in accordance with the present invention.

RAM 770 and disk drive or non-volatile memory 780 may include a number of memories including a main random access memory (RAM) for storage of instructions and data during program execution and a read only memory (ROM) in which fixed instructions are stored. RAM 770 and disk drive or non-volatile memory 780 may include a file storage subsystem providing persistent (non-volatile) storage for program and data files. RAM 770 and disk drive or non-volatile memory 780 may also include removable storage systems, such as removable flash memory.

Bus subsystem 790 provides a mechanism for letting the various components and subsystems of computer 720 communicate with each other as intended. Although bus subsystem 790 is shown schematically as a single bus, alternative embodiments of the bus subsystem may utilize multiple busses.

FIG. 5 is representative of a computer system capable of embodying a portion of the present invention. It will be readily apparent to one of ordinary skill in the art that many other hardware and software configurations are suitable for use with the present invention. For example, the computer may be a desktop, laptop, portable, rack-mounted, smart phone, phablet or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a wearable-computing device such as a smart-watch or smart-glasses by way of an example, it is understood that the invention is not limited by the type of wearable-computing device. Although, the invention has been described with reference to a portable-computing device such as a smart-phone by way of an example, it is understood that the invention is not limited by the type of portable-computing device. Although, the invention has been described with reference to certain radio communications interface by way of an example, it is understood that the invention is not limited by the type of radio, wireless, or wired communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A method for broadcasting a request by a first device, comprising:
determining first information corresponding to a location of the first device;
transmitting the first information and a user request to a server, said user request to be transmitted to one or more devices in a first set of devices associated with the first device;
receiving at least one resulting information in response to the user request; and
displaying the at least one resulting information to the user of the first device.

2. The method of claim 1, further comprising:
transmitting one or more lists of devices associated with a user of the first device to the server.

3. The method of claim 1, further comprising:
receiving one or more advertisement elements from the server; and
displaying the one or more advertisement elements to the user.

4. The method of claim 3, wherein the one or more advertisement elements are displayed in a ranked order.

5. The method of claim 3, further comprising:
receiving an input corresponding to a selection of at least one of the advertisement elements from the user;
transmitting the input to the server.

6. The method of claim 1, wherein displaying the at least one resulting information comprises:
transmitting the at least one resulting information to a second device associated with the user of the first device to be displayed to the user.

7. The method of claim 1, wherein the first information corresponds to measurements from one or more environmental sensors.

8. The method of claim 1, wherein the first information correspond location information associated with an internet protocol (IP) address of the first device.

9. A method for broadcasting a request by a server, comprising:
receiving a user request and first information corresponding to a location of a first device;
correlating first information with a second set of information to select one or more devices from a first set of devices;
transmitting the user request to the selected one or more devices;
receiving at least one resulting information from at least one of the selected one or more devices in response to the user request;
transmitting the at least one resulting information to the first device.

10. The method of claim 9, further comprising:
selecting one or more advertisement elements from a third set of data according to the user request; and
transmitting the one or more advertisement elements to the first device.

11. The method of claim 10, further comprising:
ranking the one or more advertisement elements according to the user request.

12. An apparatus for selecting advertisement information, comprising:
a memory; and
at least one processor coupled to the memory, the at least one processor configured to:
determine first information corresponding to a location of the apparatus;
transmit the first information and a user request to a server, said user request to be transmitted to one or more devices in a first set of devices associated with the apparatus;
receive at least one resulting information in response to the user request; and
display the at least one resulting information to the user of the apparatus.

13. The apparatus of claim 12, wherein the at least one processor is further configured to:
transmit one or more lists of devices associated with a user of the apparatus to the server.

14. The apparatus of claim 12, wherein the at east one processor is further configured to:
receive one or more advertisement elements from the server; and
display the one or more advertisement elements to the user.

15. The apparatus of claim 14, wherein the one or more advertisement elements are displayed in a ranked order.

16. The apparatus of claim 14, wherein the at least one processor is further configured to:
receive an input corresponding to a selection of at least one of the advertisement elements from the user;
transmit the input to the server.

17. The apparatus of claim 12, wherein the at east one processor is further configured to:
transmit the at least one resulting information to a second device associated with the user of the apparatus to be displayed to the user.

18. The apparatus of claim 12, wherein the first information corresponds to measurements from one or more environmental sensors.

19. The apparatus of claim 12, wherein the first information correspond location information associated with an interact protocol (IP) address of the apparatus.

20. An apparatus for selecting advertisement information, comprising:
a memory; and
at least one processor coupled to the memory, the at least one processor configured to:
receive a user request and first information corresponding to a location of a first device;
correlate first information with a second set of information to select one or more devices from a first set of devices;
transmit the user request to the selected one or more devices;
receive at least one resulting information from at least one of the selected one or more devices in response to the user request;
transmit the at least one resulting information to the first device.

21. The apparatus of claim 20, wherein the at least one processor is further configured to:
select one or more advertisement elements from a third set of data according to the user request; and
transmit the one or more advertisement elements to the first device.

22. The apparatus of claim 20, wherein the at least one processor is further configured to:
rank the one or more advertisement elements according to the user request.

23. A non-transitory computer-readable medium comprising computer readable instructions configured to cause a processor to:
determine first information corresponding to a location of the first device;
transmit the first information and a user request to a server, said user request to be transmitted to one or more devices in a first set of devices associated with the first device;
receive at least one resulting information in response to the user request; and
display the at least one resulting information to the user of the first device.

24. A non-transitory computer-readable medium comprising computer readable instructions configured to cause a processor to:
receive a user request and first information corresponding to a location of a first device;
correlate first information with a second set of information to select one or more devices from a first set of devices;
transmit the user request to the selected one or more devices;
receive at least one resulting information from at least one of the selected one or more devices in response to the user request;
transmit the at least one resulting information to the first device.
